(19) United States
(12) Patent Application Publication
(10) Pub. No.: US 2003/0103644 A1
(43) Pub. Date: Jun. 5, 2003

(54) System and method for directed advertising

(76) Inventor: John Klayh, Winnipeg (CA)

Correspondence Address: Shapiro Cohen, Station D, P.O. Box 3440, Ottawa, ON, K1P 6P1, CA

(21) Appl. No.: 10/207,124

(22) Filed: Jul. 30, 2002

Related U.S. Application Data
(63) Continuation of application No. 09/218,455, filed on Dec. 22, 1998, now abandoned.

(51) Int. Cl. G06K 9/00

(52) U.S. Cl. 382/100

(57) ABSTRACT

A method for presenting advertising to a person, comprising storing plural advertisements in a memory, detecting the presence of a person adjacent a display apparatus, selecting one of the plural advertisements, and displaying the selected advertisement via the display apparatus upon detection of the person adjacent the display apparatus.

This application is a continuation application of U.S. application Ser. No. 09/218,455 filed Dec. 22, 1998

### FIELD OF INVENTION

This invention relates to the field of data communications, and in particular to a method and a system for precision distribution of advertising to particular persons or locations.

### BACKGROUND TO THE INVENTION

Advertising has generally been displayed or broadcast to masses of potential customers, such as by print media, radio and television, billboards, etc. In some special cases, advertising is narrowcast, i.e. transmitted or supplied to special classes of potential customers, such as by push technology used in internet world wide web data distribution. Narrowcasting is also used where such persons have requested certain kinds of information or have been identified as having certain interests, whereupon advertising is be sent to those persons by computer or by direct mail. In CATV narrowcasting, set-top box addresses of certain classes of cable subscribers are used to distribute restricted information, such as medical programs or on-line magazines to physicians, e-mail, etc., to addressed set-top boxes for display on a TV set.

However, in all of the above cases, there is no reasonable certainty that a particular potential target customer actually sees any particular advertisement. As such, advertising distribution using the above-described media inherently has a large degree of inefficiency. Only by sample polling can an advertiser have a reasonable idea of the viewership of its advertising.

Electronic transaction processing has come into widespread use. For example, retailers commonly use card swipe terminals which read information stored on a magnetic strip carried by a credit or debit card. The information is received by telephone line at an administration office, where a computer checks the credit of the customer that has been identified, using the credit or bank balance stored in a database, and provides an authorization number or denial of the transaction to the retail.

Advertising is sometimes presented to the customer by means of static card displays located adjacent the card swipe terminal. In some cases, a nearby video tape player repetitively plays the same commercial message. In this case as well, an advertiser does not know whether a particular advertisement has been seen by a particular potential customer. The advertiser has no means to direct specific advertising to specific customers, with reasonable certainty that the specific customers will view the advertising.

It is common that some credit card issuers record loyalty points, for example a point for each dollar purchased on the credit card. These points are accumulated by the credit card issuer to the credit of the credit card user, and can be redeemed for merchandise typically advertised in a catalogue. In some cases, loyalty points given for use of a credit card are accumulated in conjunction with a particular vendor, such as an airline, wherein the loyalty points can be used for airline travel with that airline.

In addition, identity cards rather than credit cards are sometimes used in the awarding of airline miles or loyalty points toward catalog merchandise for purchases from certain vendors.

In such cases, the card issuer and the vendor (e.g. the airline) each retain a separate simple database to keep track of the value of points accumulated and retained after redemption for travel or merchandise.

However, in each such case, there is a single authority which has issued the card, and tie-ins of a single card with a limited number (often only one) of merchants. For example, a card issuer may have a tie-in with several merchants to provide discount on merchandise or services. In such a case, no loyalty points are awarded to the customer for patronizing a particular merchant, but loyalty points can be awarded based on use of the card. The systems are not capable of dispensing or redeeming premiums or loyalty points “on-the-spot” for certain actions that can be undertaken by customers, for example for viewing certain advertisements.

The systems are not capable of displaying advertising directed to specific customers who have identified themselves or have been identified at a terminal, or have undertaken certain activities such as purchasing a service, nor for tracking what advertising has been displayed to particular customers or classes of customers, nor for controlling what advertising is shown to such customers.

Neither are the systems capable of allowing the loyalty points won or otherwise acquired to be used as a medium of exchange between member merchants, e.g. exchanging points won playing a video game or obtained for presumably viewing an advertisement for premiums which can be redeemed by various merchants.

### SUMMARY OF THE INVENTION

The present invention which can display directed advertising to identified persons or classes of persons can be implemented in an integrated on-line system which can accumulate also exchange values associated with any customer from any merchant which has authorized access to the system. The advertising display schedule, as well as the awarded exchange values for any transaction can be controlled by an administrator or by authorized plural administrators, and can in addition be varied by location of the customer, by customer activity, by time and/or date, and by past history of either the activity itself or of the actions of the customer.

In addition, the administrator can vary the characteristics of whatever software program the customer, merchant, etc. is interacting with. For example, the program can be a video game operating in a system of the type described in U.S. Pat. No. 5,083,271 issued Jan. 21, 1992, or on personal or public computer. The program can be an advertisement displayed on a video terminal which can be one of the games described in the aforenoted U.S. patent, or on a personal or public computer, including a video telephone, a network computer interacting communicating via a private network, the internet, cable or the equivalent, or a telephone line. The program can alternatively or additionally involve scoring of sporting events, scoring of school tests, operate applications such as e-mail, etc. The advertisement can be shown in one or more frames which share the display with a game, or can occupy the entire display area. The advertisement can be directed to a particular player, or to a class of customer to which the player belongs, and/or can be scheduled based on time and/or date and/or location at which it is to be presented. The advertisement can be changed based on various criteria, such as the location of the display, how many times it has been run, how many times it has been directed to the customer or class of customer at a particular display or display location or at plural particular or classes of locations.

Further, particular advertisements can be automatically restricted from being displayed at predetermined display locations, such as those where the advertisements are unsuitable for display, for example cigarette or liquor advertisements in a location frequented by children.

In the system, games can be changed and varied as to degree of difficulty and currency or exchange value price to participate, competition brackets can be set up and varied, thresholds for prizes can be established and varied, prize and premium values can be accumulated for various activities such as being present adjacent a display apparatus which plays an advertisement, game plays, purchases, loyalty, and/or timing, customers or players can be authorized or disqualified, advertising can be directed to certain customers or classes of customers as noted above, premiums can be accumulated and dispensed and prizes awarded across any kind of commercial or non-commercial activity with controllable interchangeability.

As an example, a customer can receive a coupon at a gas bar (or can read an announcement in a newspaper) containing a question to be answered, and if answered correctly at a terminal used in the system of the present invention, a prize (e.g. a coupon for $1000 off the price of a purchase, or the awarding of loyalty points which can be exchanged for merchandise or service at participating or at all merchants) can be awarded by the system, and the accounts of the customer, merchants and administrator incremented or decremented as required. The coupon or announcement constitutes an inducement to attend a terminal, where advertising can be directed to the customer, since by angering the question, the customer must identify himself.

The present invention thus provides for the first time an efficient way of combining the loyalty point and premium systems of any (rather than restricted) merchants and at the same time gathering activity information about the customers of those merchants so that advertising may be targeted and efficiently delivered to those exact customers which can best benefit from the advertising. By the use of the term merchants, included are merchants not only of merchandise, but also of services including the services of video games.

An embodiment of the present invention is a method for providing advertising to a person comprising storing plural advertisements in a memory, detecting the presence of a person adjacent a display apparatus, selecting one of the plural advertisements, and displaying the selected advertisement via the display apparatus upon detection of the person adjacent the display apparatus.

In accordance with another embodiment, the detecting step comprises detecting an identity of a specific person or class of person adjacent a display apparatus, and the selecting step includes selecting one of a predetermined sequence of advertisements for the identified person or class of person, and then displaying the selected advertisement via the display apparatus where the identified person or class of person has been identified.

In accordance with another embodiment, the method includes storing advertisement target indicators against specifically identified persons or classes of persons in a database, and in which the selection step is comprised of accessing the database, looking up a group of target indicators against a specifically identified person or class of person, and selecting one of a plurality of advertisements based on one of the target indicators matched to the specifically identified person or class of person for display.

In accordance with another embodiment, the detecting step comprises detecting an identity of a specific person or class of person adjacent a display apparatus and a specific activity of the specific person or class of person, and the selecting step includes selecting one of a predetermined sequence of advertisements for the specific activity of, and the identified person or class of person, and displaying the selected advertisement via the display apparatus where the identified person or class of person has been identified.

In accordance with another embodiment, the database includes at least one exclusion code for restricting display of an advertisement on a particular one or group of display apparatus.

In accordance with another embodiment, a system for providing advertising to a person or class of person comprises:

(a) a display apparatus,

(b) a person or class of person identifying apparatus located adjacent the display apparatus,

(c) an advertising player for playing advertisements on the display apparatus,

(d) a database stored in a memory, the database containing correlations of advertisements with at least one of: persons or classes of persons, and activities undertaken by or on behalf of persons or classes of persons to which predetermined sequences of advertisements are to be displayed, and

(e) apparatus for detecting at least one of a person or class of person and an activity undertaken by or on behalf of the person or class of person, for accessing the database and for determining an advertisement of a group of advertisements correlated to the at least one of an activity, person and class of person, and for providing a control code to the advertising player to cause a particular advertisement or sequence of advertisements to be displayed on the display apparatus.

### BRIEF DESCRIPTION OF THE DRAWINGS

A better understanding of the invention will be obtained by a consideration of the detailed description below, in conjunction with the following drawings, in which:

FIG. 1 is a block diagram of a preferred embodiment of a system on which the present invention can be implemented,

FIG. 2 is a flow chart of call initialization,

FIG. 3 is an illustration of a database format for specifying advertisements to be played under various circumstances, and

FIG. 4 is an illustration of an exclusion code signal.

### DETAILED DESCRIPTION OF EMBODIMENTS OF THE INVENTION

The aforenoted U.S. Pat. No. 5,083,271 is incorporated herein by reference. That patent describes plural game arcades which are in communication with a central computer, or with one of plural regional computers which communicate with a central computer. The regional computers receive game score data and compute tournament winners, downloading both winner information and advertising to local games at the game arcades.

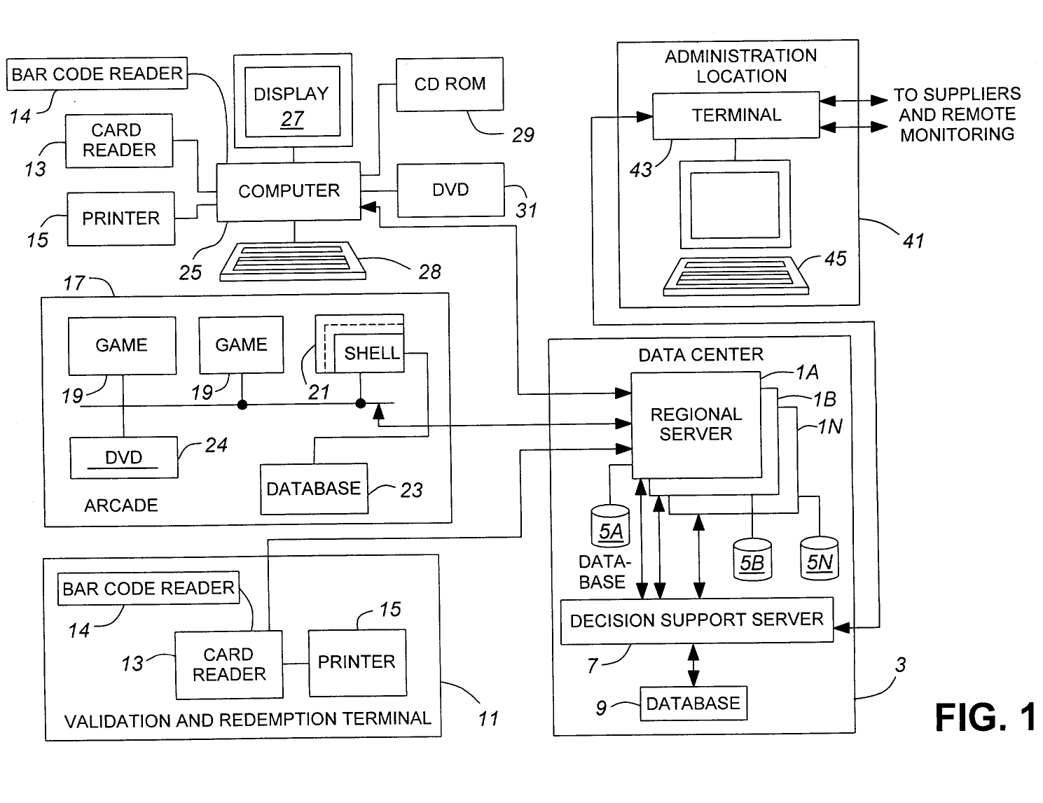

Turning to FIG. 1, in place of the regional computers described in the patent, regional servers 1A, 1B . . . 1N, etc. are used. Each regional server is located at a separate regional data center, although for convenience of illustration they are all shown in this Figure in data center 3.

Each regional server has a memory containing a corresponding database 5A, 5B . . . 5N coupled to it. In the aforenoted patent, the corresponding memory stores not only score data, but also values of money on deposit to be credited against the playing of a game, and handicaps of players and/or games. In accordance with an embodiment of the present invention, the databases 5A, 5B . . . 5N also store parameters and content relating to advertising, premiums, etc., and can also store specialized data relating to parameters used in a game, such as difficulty levels, points to be awarded for certain game activities, and other functions to be described in more detail below, as well as parameters and content relating to advertising, premiums, loyalty points, etc.

The data to be stored in databases 5A . . . 5N is loaded by a decision support server 7, from data stored in a database 9 with which it communicates.

Validation and redemption terminals 11 are in communication with the regional servers 1A . . . 1N. Each of the terminals 11 is comprised of a card reader 13 and preferably a bar code reader 14, smart card reader, or the equivalent, coupled to a printer 15. The card reader is preferably also a card writer for writing the magnetic stripe on a card and/or for updating, debiting or crediting one or more values stored on a smart card (a card which carries a processor or the equivalent and a memory). The term card reader is used in a general sense, since it can include a keypad or keyboard which can be used by the customer and/or merchant. The card is also a specific person or class of person identifier, the identification being stored by the magnetic strip or chip on the card. However, persons can alternatively be identified by any other means, such as by voice recognizer, palm or finger print detector, iris reader, etc.

The printer is used to print receipts and coupons, preferably with a bar code. The card reader can be based on the type made by Verifone Corp. for swiping cards and dialing a credit or debit card administration office.

A terminal 11 should be located at the premises of each associated merchant authorized to use the system, and in addition can be located at one or plural arcades 17 or other single or multi-terminal system. A system, which can be, but is not limited to arcade 17 which is similar to the system described in the aforenoted patent is in communication with a corresponding server, in a manner as will be described later. However, rather than each game 19 communicating directly with a regional server via its own interface, it is preferred that it communicate with a regional server through a master game 21, via shell software which uses a particular communication protocol which can encrypt data. This will be described in more detail later. A database 23 is also coupled to the master game 21.

A computer 25, referred to below as a public PC 25, can be in communication with an associated regional server 1A . . . 1N. Preferably a card reader 13, bar code reader 14 and printer 15 are coupled to the computer, as well as a display 27, keyboard 28, game controls (e.g. a joystick, mouse, trackball, pedals, etc.) a CD ROM player 29, and a DVD (digital video disk) player 31 or hard drive.

An administration office 41 contains a computer terminal 43 preferably operating in a Windows™ software environment, with a display 45. Rather than a Windows™ software environment, any type of operating system can be used, such as one which will operate under control of applets downloaded from the internet or any other network, MacIntosh, OS/2, etc. The terminal 43 includes a database and a processor for controlling parameters of software used in the system, and can communicate with the decision support server 7 as will be described below.

In operation, games, advertising and parameters relating to loyalty points and/or coupons are downloaded under control of the decision support server 7 to database 9, then are distributed to regional servers 1A . . . 1N for storage in database 5A . . . 5N, and are downloaded to database 23 via master game 21. The games and advertising can be stored in digital form. Alternatively the games, parameters and/or advertising are stored at the arcade 17 on local mass storage devices such as hard disk drives, digital versatile disks (DVDs) or CD ROMs (or can be stored in a semiconductor or any other form of mass storage memory), and are enabled from data stored in the decision support software. The games, parameters and/or advertising can be provided via applet if desired. In the description below, and only for this example, the games and advertising will be described as being stored on DVDs (in database 23) at the arcade. The database will be considered for this example to be a combination of the local mass storage and semiconductor memory, but it should be understood that the data can alternatively be downloaded from database 5A to 5N coupled to the regional server, and stored for use as needed in the database 23.

The advertisements are preferably written within a shell, with software “hooks” between the advertisements and shell. The shell should be responsible for starting and stopping the advertisements, altering their parameters if desired, controlling the display of the advertisement that is to be played, and communicating with the regional server 1A . . . 1N. The software operated by the master game device 21 should be designed to communicate with and control each of the DVDs and other game devices of the arcade, and with a designated regional server using a communications manager program, in accordance with a predetermined protocol. Subscriber accounts are retained in the database 9, and are preferably comprised of the following fields:

1. Account data (customer name and PIN),

2. Balance of account (in currency), both current balance and pending balance (the latter being the expected balance after an ongoing transaction has been completed),

3. The identity and value of coupons and premiums allocated to the subscriber,

4. The balance value of loyalty points associated with the customer, e.g. having been incremented or decremented under control of a device such as by an input device at a merchant location (for example by inputting data via a keypad connected to the card reader 13 at a validation and redemption terminal 11) or by an administrator via terminal 43 at the administration location 41, or by operating an automatic terminal such as a coin telephone having a swipe card reader in administrative communication with regional server 1A to 1N, a game machine, etc., or by the regional server having received information that a particular advertisement has been displayed on a display device such as a game machine, public computer, television monitor, etc. adjacent to which a specifically identified customer has been identified

5. Game ratings, such as skill level of the subscriber for variously played games, handicap values of the subscriber for variously played games, profiles (e.g. how much time is allocated to the player to complete various games),

6. Viewing history of advertising (e.g. a record of the most recent time that the subscriber has viewed a particular advertisement),

7. Images displayed for this subscriber,

8. The identities of identification cards issued to the player,

9. Merchandise orders, e.g. the identity and loyalty point, premium or currency cost of merchandise that has been ordered, the date ordered, the date the order was sent to the supplier, the date the order was shipped, etc.,

10. The game played history, e.g. for each game played, the rank achieved, number of players in a game or tournament, etc.,

11. Data regarding membership of the customer in competitions or teams,

12. Records of payments of fees made by the customer, and

13. Records of customer premiums and/or prizes awarded (which can be used e.g. for tax computation).

The administrator characterizes each game and activity relating to merchant products and services with certain parameters, and downloads these parameters from terminal 43 to server 7. For example, the administrator establishes game formulae for each game, loyalty points (or none) for playing each game, for patronizing particular merchants, for being adjacent a display apparatus which displays a particular advertisement, etc.

When a subscriber is issued an identity (ID) card, a PIN number is issued in a well known manner, and information regarding its issuance is uploaded from a validation terminal 11 to the associated regional server 1A to 1N. A record in the database 9 relating to this subscriber is established by server 7. The record is seeded by the parameters provided by the administration terminal to the server 7. For example, upon first initiation of the record, a number of loyalty points can be deposited to the subscriber, and recorded in the database in field 4.

The subscriber then pays currency to play say, 5 video games. The payment value is entered by swiping the ID card in a local card reader in the arcade, and by then entering the PIN number of the subscriber and the number of games to be played, or a currency amount into a local keypad. This amount is stored (deposited) in database field 1 (see the above field list) of database 9, after uploading from the arcade 17 via master game 21.

The subscriber then goes to the game and swipes his card in a card reader associated with the game. The request to initiate the game is sent to the game from the card reader, and value of the game play is sent to the decision support server 7. Server 7 addresses database 9, and selects the record of the subscriber from the card number read and provisionally decrements the amount on deposit, storing the resulting pending balance. If the game is not played (e.g. if there is a power outage), the pending balance is again incremented back to the previous balance after a predetermined amount of time.

By using the decision support server 7 and database 9 to store the subscriber accounts, the subscriber can be provided with the service and with any advertisement at any location which communicates with any regional server. A duplicate account is established and retained in the regional support server database 5A . . . 5N, the records being mutually updated from time to time.

At the time of establishment of the record in database e.g. 5A, the server 7 would also store values in the remaining fields of the record. For example, it would store an advertisement value, to be described in more detail below, in field 6, indicating that no ads have been presented to the subscriber.

After the subscriber has swiped his card at a game, and thus identifies himself, the local database provides a data message to the local system which enables the selected game. If it is the first time the customer has identified himself to the local system, the regional server e.g. 1A sends a data message which enables the selected game. It also enables a DVD to run an advertisement to the game via its shell, which overlays in a window, or is presented with or prior to, the initial screens and/or the final screens, of the game. For example, the initial screen can be a “welcome to a new player” screen, with an advertisement relating to one or another of the associated merchants. The advertisements to be run are pre-established at the administration terminal 43.

The fact of running a particular advertisement and of the subscriber being located at a particular game (determined from his ID card) is then stored in the 10^{th} field of the record. When the game has been completed, the score is uploaded to-the regional server and the rank of the player is established and is stored in the 10^{th} field. The number of plays of the player of that game, and of other games, are also stored in the 10^{th} field. On the basis of this, depending on the administrator, loyalty points, coupons or premiums can be provided to the subscriber.

For example, if the subscriber has achieved a particular score, a predetermined number of loyalty points can be awarded, and added to those in the balance in the 4^{th} field of the database record. A printer 15 can dispense a coupon to the subscriber e.g. for a discount on a food item at a fast food outlet, the serial number and value of which is recorded in the 3^{rd} field of the record. The printout can also record the score and the game that was played.

The identity of the advertisement which was run is recorded in the 6^{th} field of the record.

The subscriber in achieving a particular amount of expertise can be handicapped by the software in the regional server 1A, and the handicap value recorded in the 5^{th} field of the record, the rank achieved recorded in the 10^{th} field, and all of this information can be printed on the same ticket as the coupon, or on another ticket.

Now assume that the player attends a different arcade, and wishes to play a game. He will swipe his ID card in the local card reader, press a button to command the start of the game if necessary, and his identity, a command to play a game and the cost to play is uploaded to the associated regional server, say server 1B. Server 1B searches its database 5B for a record of the identified subscriber, and doesn't find it. It then sends an inquiry to the server 7, which sends an inquiry to each of the other regional servers. Server 1A responds, and provides an indication to server 1B that the subscriber record is stored in a database associated with server 1A.

Server 1A then sends the record of the subscriber to server 1B via server 7. Server 1B checks whether the second field has sufficient balance to pay for the game. On the indication that it does, a provisional decrement is done as described earlier, and server 1B sends a signal to the master game of the arcade to enable the game.

The server 1B also checks the advertisement view history and image last viewed, and enables the DVD at the arcade to run the next advertisement in the predetermined sequence of advertisements to the game to be played, via the game shell. The entire process is repeated as described earlier.

In the event the customer has used the local system before, and his identity data, etc. is stored in the local database, the above process can be carried out using the data stored in the local database, rather than using the data stored in the server.

The score can result in loyalty points or premiums being awarded to the player, which is stored in the account of the player.

Assume now that the subscriber wishes to redeem loyalty points or premiums. The subscriber can visit a validation and redemption terminal, which can be at the location of a merchant, a public PC, or at an arcade. The ID card of the subscriber is read, and an, attendant types in a request on a local keyboard such as 28 to obtain the number of loyalty points, or the identities of coupons or premiums held by the subscriber. This request is uploaded to the regional server, which reads the database e.g. 5A and accesses the record of the subscriber identified by the card (and PIN number, if desired). On verification by the regional server, the data stored in the fields of the information requested by the attendant are then downloaded to the local terminal, such as computer 25, and is displayed on display 27.

The customer can ask for redemption of the value of the coupon. For example, if the validation and redemption center is at a fast food outlet, and the coupon is for a discount on a hamburger from the fast food outlet, the merchant can sell the hamburger at the required discount, take the coupon from the subscriber, and key in the coupon on a keypad or read a barcode or magnetic stripe or the equivalent carried by the coupon, to identify it and record it as having been redeemed. The local computer or the equivalent then uploads this data to the regional server 1A, which records that the coupon has been rendered.

While this transaction is going on, there could be a display adjacent the redemption equipment. The regional server, in learning of the presence of the subscriber at that location from the ID card swipe, can then look up the advertisement viewing history from the 6^{th} field of the subscriber's record in the database, and send a control signal to the computer or the equivalent at the redemption center, to enable a local DVD 31 to run the next advertisement in a predetermined sequence to the display which is adjacent the subscriber. Loyalty points can be awarded to the identified subscriber based on one or both of having had the advertisement displayed adjacent to him, and having carried on a particular activity, such as purchasing a product or service (e.g. operating a video game, transmission of an e-mail via a public PC, etc.) from a merchant.

It should be noted that because the customer and his activity have been detected at a specific location, and the advertisement run via a display apparatus which is adjacent the customer (for example, on the game apparatus screen of a video game he is playing), the advertiser has more certainty than in mass media that the advertisement has been viewed by the designated customer or class of customer. Further, since the specific customer or class of customer has been identified, an advertisement particularly targeting that customer or class of customer has been displayed to that customer or class of customer, which the advertiser has reasonable certainty has been veiled by the specifically identified customer or class of customer. The efficiency of advertising is thereby considerably enhanced, and the value of advertising is thereby considerably increased.

Loyalty points can be redeemed, by the subscriber attending a redemption center which can be located at a merchant location, or at a special catalog store. After swiping the ID card of the subscriber and keying in a request to display the number of loyalty points accrued to the subscriber, the regional server e.g. 1A accesses the record of the subscriber, using his ID and PIN number, in database e.g. 5A, and downloads the information to a local display. Following redemption of a particular number of loyalty points for the merchandise or services requested, the 4^{th} field of the record of the subscriber is decremented by the value of the loyalty points redeemed.

In this case as well, advertising targeted to the specifically identified customer or class of customer can be displayed on a display apparatus located adjacent the customer.

It should be noted that the system is global, in that any merchant can have a redemption terminal. Upon redeeming loyalty points which have been accrued by the subscriber by playing games, viewing advertisements, or using services of other merchants, etc., the redeeming merchant can be owed a certain value based on the redemption. This value or the equivalent in loyalty points, can be stored in (credited to) a database 5A related to the merchant. When a subscriber purchases goods from that merchant, a certain number of loyalty points can be awarded the subscriber, and the balance debited from the balance of the merchant. Administrator service fees in the form of loyalty points can be accrued to an account of the administrator for each transaction. In this manner, loyalty points become a medium of exchange for the subscriber, the merchants and the administrator.

Loyalty points, or a monetary amount can be decremented from an account of each merchant for each play of its advertisement.

At the end of a predetermined period, for example quarterly, yearly, etc., the administrator and merchants can settle the accounts, e.g. collecting a prescribed monetary value for negative balances of merchant loyalty point accounts, and paying a prescribed monetary value for positive balances of merchant loyalty point accounts.

Loyalty points can also be redeemed by the subscriber for any merchandise or service at any merchant location or venue at which a service terminal is located, or for game play at an arcade.

Two types of data interchange are preferably used in the system: synchronous and asynchronous. In synchronous interchanges, the client initiates a connection to a server, sends a request, and awaits a reply, in a manner similar to credit card authorizations in retails stores. An example of this type of interchange in an embodiment of the present invention is the validation of a prize receipt. Asynchronous interchanges are used for database synchronization. They allow events that have been queued by clients to be sent to servers, and allow servers to add or update information in a client's database.

Four modes of communication between clients and servers are preferred to be used:

Queries from clients to servers for specific information,

Events being transmitted from clients to servers,

Record and file system synchronization transmitted from servers to clients, and

Interactive on-line traffic, allowing on-line services in which processing is done in real-time by the server, or through a proxy process on the server.

Because of the short duration and unpredictability of query calls, they are preferably implemented with a point-of-sale, packet type transaction type network, with dial-in connections from various client locations using a global toll-free number.

The remaining types of calls are more predictable in nature and duration, typically lasting one or more minutes, and preferably use full duplex stream-oriented communications. This can be implemented using a dedicated or non-dedicated dial-up line between client and server, using TCP/IP ports (internet or intranet).

Thus each server can initiate two types of connections to client servers: asynchronous dial-in to the transaction network at relatively low speeds (e.g. 2400 baud or higher) for short duration queries, or via a dial-in PPP connection (e.g. 28.8 kbaud or higher) or ISDN to perform sockets-based communication.

The data transmission protocol used is preferred to be bi-directional full-duplex asynchronous communication using X.25-based packet switching, but other communications technologies, e.g. ADSL can be used, as they become widely available. Prior to application to the network, the event data should be packetized, inserted into variable length telecommunication packets, compressed and encrypted using the encryption key of the location. Other fields in the telecommunication packet need not be compressed or encrypted. The received packets should be decrypted, decompressed, and extracted from the telecommunication packets.

The transmissions are preferably initiated from the transmitting entity (dial-in) rather than being polled. The calls can be normal (e.g. to pass data re start, game plays, alarms, meters, etc. to and from the client, stored in a queue at that location for subsequent transmission), urgent (e.g. such as subscriber information when a card is swiped), and receipt validation (e.g. to verify calls used by validation terminals).

Terminals communicating within a single location can use 10baseT twisted pair wiring and 802.3 (Ethernet™) standard for data link management, or higher speed Ethernet™ or other technologies, as they become available. The regional servers can accept connections from either the point-of-sale transaction network or from a TCT/IP internet/intranet connection (using Berkeley sockets). The same application-layer protocols operate over each connection, with the possible exception of synchronization, which can operate only over TCP/IP connections, if desired.

The four types of packets referred to above can have a number of subtypes, as follows:

| Packet | | |
|---|---|---|
| Type: | Possible Subtypes | |
| Control | Acknowledgment (ACK) | Negative |
| | | Acknowledgment (NAK) |
| | Context Negotiation | Ping |
| | Ping Response | Open Query Link |
| | Close Query Link | Open IP Link |
| | Close IP Link | Link Status Request |
| | Link Status Response | Suspend Processing |
| | Suspend Processing Response | Resume Processing |
| | Resume Processing Response | Synchronize |
| | Synchronize Response | |
| Query | Test | Test Response |
| | Receipt Validation | Receipt Validation Response |
| | Subscriber Information | Subscriber Information |
| | | Response |
| | Account Withdrawal | Account Withdrawal |
| | | Response |
| | Account Deposit | Account Deposit Response |
| | Subscriber Account Data | Subscriber Account Data |
| | Request | Response |
| | Winning Redemption Play | Winning Redemption Play |
| | | Response |
| | Subscriber ID Request | Subscriber ID Response |
| | Credit/Debit Request | Credit/Debit Response |
| | Save State Request | Save State Response |
| | Restore State Request | Restore State Response |
| | New Subscriber Card Request | New Subscriber Card |
| | | Response |
| | Reserve Merchandise | Reserve Merchandise |
| | | Response |
| | Purchase Merchandise | Purchase Merchandise |
| | | Response |
| | Release Merchandise | Release Merchandise |
| | | Response |
| | Subscriber Ranking Request | Subscriber Ranking Response |
| Event | Alarm | Tournament Play |
| | Redemption Play | Meter Readings |
| | Ad Statistics | Service Accesses |
| | Down Times | New Subscriber |
| | New Team | Issued Coupons |
| | Loyalty Point Awards | |
| Synchro- | Inventory | Table Download |
| nization | File Initial Download | File Next Download |
| | File Initial Upload | File Next Upload |

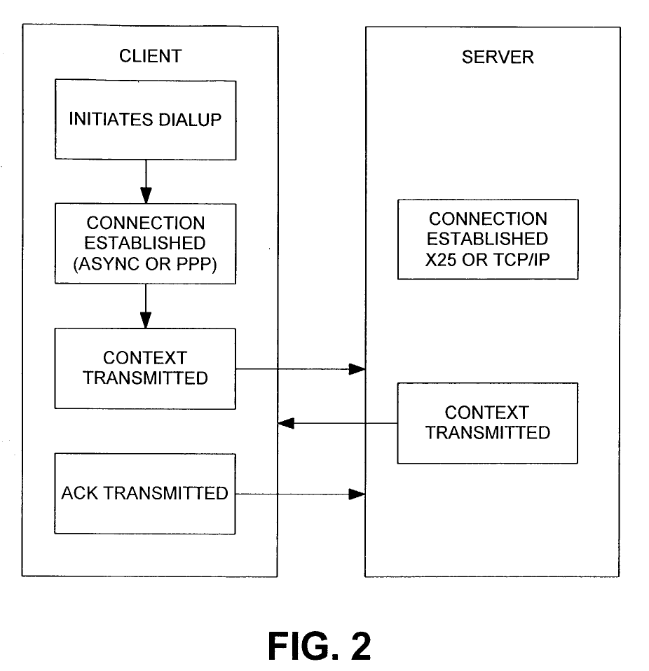

When a call is connected over the point of sale network or either of the TCP/IP ports, the client and server exchange context negotiation packets to configure the session communications, as shown in FIG. 2. When both parties have acknowledged the context negotiation, data packets can begin.

The client sends a context negotiation packet with the settings it wishes to use for the call (including the encryption and compression parameters). This packet also tells the server what type of call this is (e.g. events, queries, etc.). The server examines the context negotiation packet and determines whether the values are acceptable. If so, it sends a context negotiation packet with the same settings to the client. The client acknowledges this packet to the server, and the call is considered to be established.

If the server cannot use the context provided by the client, it sends its own context negotiation packet back to the client with its preferred settings (e.g. a “lower” standard for compression or encryption). If the client agrees with these settings, it sends an acknowledgment to the server, and the call is considered to be established.

The contents of the context packet are sent uncompressed, but encrypted using the terminal's 16 byte license key and a TEA encryption algorithm. The terminal cannot operate unless the license key entered at the machine matches the key entered through the server administrative application.

If a device receives a context packet for an encryption method it can perform, it can NAK (unacknowlege) the packet. The server should retransmit session key packets, working from best to worst encryption (retrying a number of times in case of communications faults) until the client returns an acknowledgment. If the client never acknowledges the packet, the server should close the connection. Likewise, if the server never acknowledges the packet from the client, the client can close the connection. The client is free to retry with a new socket on the same call.

When a connection is established over the asynchronous point of sale link, the client may immediately begin transmitting data packets to the server. Then a PPP connection is established, the client should create a socket connection to one of the TCP ports listed above. Packets can then be sent over this socket connection. Multiple socket connections can be opened to allow parallel processing of synchronization, event and query traffic.

Query exchanges preferably and occur in lockstep over a single connection. When a terminal issues a query, it waits on the same connection for a matching query response to arrive. The terminal then processes the query response, sends an acknowledgment, then closes the connection or continues with other query exchanges.

If a query initiates the download of table and/or file information to the client, the downloads should take place before the server sends the query response. When the query response is received at the client, it can assume that all downloads are complete.

Event transfer from clients to servers follows a lockstep acknowledgment cycle in which the client sends event packets and the server sends acknowledgment or nonacknowledgement packets in response. Events should remain in the client's event queue until an acknowledgment has been received from the server. When all events have been sent and acknowledged, the client can close the connection.

When a client makes a synchronization call, the client and server begin by exchanging inventory packets. The client sends an inventory of all data currently loaded, and the server sends an inventory of what the client should have (including table records and files).

The client should use the server's inventory to delete all records and files that are not present at the server. The server should use the client's inventory to build a set of table and file download packets to send new information to the client.

Once the inventories have been exchanged, the server should begin sending table and file download packets. The client should respond to these with either an acknowledgment or nonacknowledgement packet. When the server has sent all records, it should send a table download packet with 0 records to indicate the end of data. The client is free to close the connection at this point.

All packets should be framed with a consistent header and trailer, to allow the protocol processor in the receiving server or terminal to distinguish between different versions of requests. A preferred packet is as follows:

| Offset:Field | Size: | DESCRIPTION |
|---|---|---|
| | | Packet type-the following values |
| | | are defined: |
| | 0 Byte | 0x80 = Control packets |
| | | 0x81 = Query packets |
| | | 0x82 = Event packets |
| | | 0x83 = Synchronization packets |

Note that the high bit is used to distinguish
these packets from earlier version packets.

Subtype-the following values are
defined:

Control packets:

| | |
|---|---|
| 1 Byte | 0 = Acknowledgement |

```
    1 = Negative Acknowledgement
    2 = Context Negotiation
    3 = Ping
    4 = Ping Response
    5 = Open Query Link
    6 = Close Query Link
    7 = Open IP Link
    8 = Close IP Link
    9 = Request Link Status
  10 = Link Status Response
  11 = Suspend Processing
  12 = Suspend Processing Response
  13 = Resume Processing
  14 = Resume Processing Response
  15 = Synchronize
  16 = Synchronize Response
```

Query packets:

```
    0 = Test
    1 = Test Response
    2 = Receipt Validation
    3 = Receipt Validation Response
    4 = Customer Information
    5 = Customer Information
        Response
    6 = Account Withdrawal
    7 = Account Withdrawal Response
    8 = Account Deposit
    9 = Account Deposit Response
  10 = Customer Account Data
        Request
  11 = Customer Account Data
        Response
  12 = Winning Redemption
  13 = Winning Redemption Response
  14 = Customer ID Request
  15 = Customer ID Response
  16 = Credit Debit Request
  17 = Credit Debit Response
  18 = Save State Request
  19 = Save State Response
  20 = Restore State Request
  21 = Restore State Response
  22 = New Customer Card Request
  23 = New Customer Card Response
  24 = Reserve Merchandise
  25 = Reserve Merchandise
        Response
  26 = Purchase Merchandise
  27 = Purchase Merchandise
        Response
  28 = Release Merchandise
  29 = Release Merchandise
        Response
  30 = Customer Ranking Request
  31 = Customer Ranking Response
```

Event packets:

```
    0 = Alarm
    1 = Tournament Play
    2 = Redemption Play
    3 = Meter Readings
    4 = Ad Statistics
    5 = Service Accesses
    6 = Down Times
    7 = New Customer
    8 = New Team
    9 = Issued Coupons
  10 = Loyalty Point Awards
```

Synchronization packets:

| | | 0 = Inventory |
|---|---|---|
| | | 1 = Table Download |
| | | 2 = File Initial Download |
| | | 3 = File Next Download |
| | | 4 = File Initial Upload |
| | | 5 = File Next Upload |
| 2 | 2 bytes | Packet size (in bytes, including the |
| | | type, subtype, size and CRC fields), |
| | | LSB first |
| 4 | N bytes | Data (see individual packet |
| | | descriptions for format) |
| | | 4+N 2 bytes CRC of packet |

Acknowledgement packets indicate the successful receipt of information. The total size of the framed packet will be 6 bytes

| Field Size: | Description: |
|---|---|
| 1 byte | Packet Type = 0x80 |
| 1 byte | Packet Subtype = 0x00 |
| 2 bytes | Packet size = 6 |
| 2 bytes | CRC |

Negative Acknowledgement (NAK)

Negative Acknowledgement packets indicate that a transmission was unsuccessful or that the receiver encountered an error processing the data. The total size of the framed packet will be 7 bytes.

| Field Size: | Description: |
|---|---|
| 1 byte | Packet Type = 0x80 |
| 1 byte | Packet Subtype = 0x01 |
| 2 bytes | Packet Size = 7 |
| 1 byte | Failure Code |

| | |
|---|---|
| 0 | Generic failure |
| 1 | System error |
| 2 | Allocation |
| | failure |
| 3 | Invalid request |
| 4 | Communications |
| | error |

| | |
|---|---|
| 2 bytes | CRC |

Context Negotiation

Context Negotiation packets have the following data structure

| Field Size: | Description: |
|---|---|
| 1 byte | Packet Type = 0x80 |
| 1 byte | Packet Subtype = 0x02 |
| 2 bytes | Packet Size = 40+ |
| 4 bytes | Location ID (LSB first) |
| 6 bytes | Terminal ID |
| [BEGIN ENCRYPTED AREA] | |
| 16 bytes | License Key |
| 1 byte | Connection type |
| 1 byte | Encryption type |
| 1 byte | Transmission Sequencing |
| 2 bytes | Key Length (in bytes, LSB first) |
| N bytes | Key Data |
| (Pad encrypted area to even 8 byte boundary with zeros) | |
| [END ENCRYPTED AREA] | |
| 2 bytes | CRC |

Location ID will be 0 in packets from the client. It will be filled in with packets from the server with the location ID configured for the terminal ID from the client, or 0 if the terminal is not configured in any location. Terminals that are not configured in any location can still access the server for some limited functions. However, if the licensing information is not correct, the server will never send a Context Negotiation packet to the client.

The license key is a value entered through the user interface at the terminal, and entered by the operator when configuring the machine in the administrative application. It is used to encrypt the encrypted area of the Context Negotiation packet. When the packet is received, the receiving node decrypts the encrypted area with its stored license key, then compares that key with the decrypted version from the packet. If the two do not match, the machine is not licensed correctly and the Context Negotiation will not succeed until this is corrected. At the terminal, a message indicating incorrect license information should be displayed or printed. At the server, the event will be logged for reporting and/or alarming.

The connection type will be one of the packet type codes (0×80 through 0×83) indicating the type of connection being made. This will indicate to the server which protocol processor to launch for the connection. Note that if more than one type of activity needs to occur on one connection, the client can send a Context Negotiation packet during the call to renegotiate the call type (and other parameters of the connection as well). When this occurs, all in-progress operations are completed, then renegotiation occurs.

The Encryption type field will be one of the following values:

| Value | Description |
|---|---|
| 0 | No encryption |
| 1 | XOR of key and plain text |
| 2 | Earlier Protocol Version |
| | encryption |
| 3 | TEA (see Appendix A for |
| | algorithm) |
| 4 | IDEA |
| 5 | RSA |

Transmission sequencing will be one of the values below:

| Value | Description |
|---|---|
| 0 | Lockstep (send packet, wait for |
| | Ack, send next packet) |

The contents of the key data will depend on the encryption type, as shown here:

| Encryption | |
|---|---|
| Type | Key Length and Key Data |
| 0 | data will be included |
| 1 | Key length will be 0, and no |
| 2 | Key length and key data |
| | can vary |
| 3 | Key length and key data can |
| | vary |
| 4 | Key length is 16, key data can |
| | vary |
| 5 | Key length is 5, key data can |
| | vary |
| | Key length and key data can |
| | vary |

For connections between terminals within a single location, or between processes on a single terminal, the terminal ID and location ID are both set to 0. The contents of the packet will not be encrypted and should have the following values:

Encryption type=0

Transmission Sequencing=0

Key length=0

This type of connection is only valid on LAN segments or between processes on a single machine.

The license key field will be filled by the terminal's license key. This allows the server process to enforce unique license keys and prevent services from establishing their own connections to the server without their own valid license keys.

Ping

Ping packets are used to test communications to the server. The total size of the framed packet will be 6 bytes.

| Field Size | Description |
|---|---|
| 1 byte | Packet Type = 0x80 |
| 1 byte | Packet Subtype = 0x03 |
| 2 bytes | Packet Size = 6 |
| 2 bytes | CRC |

Upon receipt of a Ping packet, the server will immediately generate a Ping Response packet and send it to the client. This does not require any database or file system access, and can be used to test the basic connection between client and server processes.

Ping Response

Ping Response packets are sent in reply to a Ping packet. The total size of the framed packet will be 6 bytes.

| Field Size: | Description: |
|---|---|
| 1 byte | Packet Type = 0x80 |
| 1 byte | Packet Subtype = 0x04 |
| 2 bytes | Packet Size = 6 |
| 2 bytes | CRC |

Open Query Link

A request that a link to the server be created that is capable of supporting query traffic (or increases the reference count of an existing link). The total size of the framed packet will be 6 bytes.

| Field Size: | Description: |
|---|---|
| 1 byte | Packet Type = 0x80 |
| 1 byte | Packet Subtype - 0x05 |
| 2 bytes | Packet size = 6 |
| 2 bytes | CRC |

This operation is intended for use between slave and master terminals within a location or between processes on a single terminal. On receipt of this packet, the recipient should establish a connection to the server suitable for query traffic. This may mean forwarding a similar request to the next higher server in the hierarchy.

If there is already a link established, its reference count is incremented.

Close Query Link

A request that a link to the server established by an Open Query Link request be closed (or the reference count of the link be decremented). The total size of the framed packet will be 6 bytes.

| Field Size: | Description: |
|---|---|
| 1 byte | Packet Type = 0x80 |
| 1 byte | Packet Subtype = 0x06 |
| 2 bytes | Packet Size = 6 |
| 2 bytes | CRC |

Open IP Link

A request that a link to the server be created that is capable of supporting IP traffic (or increases the reference count of an existing link). The total size of the framed packet will be 6 bytes.

| Field Size: | Description: |
|---|---|
| 1 byte | Packet Type = 0x80 |
| 1 byte | Packet Subtype = 0x07 |
| 2 bytes | Packet Size = 6 |
| 2 bytes | CRC |

This operation is intended for use between slave and master terminals within a location or between processes on a single terminal. On receipt of this packet, the recipient should establish a connection to the server suitable for all types of traffic. This may mean forwarding a similar request to the next higher server in the hierarchy.

If there is already a capable link established, its reference count is incremented.

Close IP Link

A request that a link to the server established by an Open IP Link request be closed (or the reference count of the link be decremented). The total size of the framed packet will be 6 bytes.

| Field Size: | Description: |
|---|---|
| 1 byte | Packet Type = 0x80 |
| 1 byte | Packet Subtype = 0x08 |
| 2 bytes | Packet Size = 6 |
| 2 bytes | CRC |

Request Link Status

A request for the current link status. The total size of the framed packet will be 6 bytes.

| Field Size: | Description: |
|---|---|
| 1 byte | Packet Type = 0x80 |
| 1 byte | Packet Subtype = 0x09 |
| 2 bytes | Packet Size = 6 |
| 2 bytes | CRC |

When a server receives this request, it should respond with the status of the link to the main ADMIN server group. This may mean forwarding a similar request to the next higher server in the hierarchy.

Link Status

Returns the current link status. Sent in response to a Request Link Status packet. The total size of the framed packet will be 6 bytes.

| Field Size: | Description: |
|---|---|
| 1 byte | Packet Type = 0x80 |
| 1 byte | Packet Subtype = 0x0A |
| 2 bytes | Packet Size = 7 |
| 1 byte | Link Status |

Low order nibble is current link status:

| | |
|---|---|
| 0x00 | Link state unknown (indicates an |
| | error) |
| 0x01 | Link is idle |
| 0x02 | Connecting asynchronous |
| 0x03 | Connecting asynchronous, IP |
| | request pending |
| 0x04 | Connecting IP |
| 0x05 | Connected asynchronous |
| 0x06 | Connected asynchronous, IP |
| | request pending |
| 0x07 | Connected IP |

High order nibble is modem state (if
applicable)

| | |
|---|---|
| 0x00 | Modem idle (or no modem in link) |
| 0x10 | Modem is dialing |
| 0x20 | Modem is waiting for answer |
| 0x30 | Modem is connected |
| 0x40 | Modem is authenticating |

High bit indicates processing is suspended

| | |
|---|---|
| 0x80 | Processing suspended |

| | |
|---|---|
| 1 byte | Query status |

High bit is one if a query is in progress
Bits 0-6 indicate the percentage complete

| | |
|---|---|
| 1 byte | Event status |

High bit is one if an event exchange is in
progress
Bits 0-6 indicate the percentage complete

| | |
|---|---|
| 1 byte | Synchronization status |

High bit is one if a database synchronization is
in progress
Bits 0-6 indicate the percentage complete

| | |
|---|---|
| 2 bytes | CRC |

The fields in the response packet relating to query, event and synchronization status are relevant only when the server process is running on a master terminal within a location. All other servers will return 0 for these three fields.

Suspend Processing

Requests that the communications process on the master terminal suspend any activity that could impact system performance. This prevents service degradation to ensure fair tournament play. The total size of the framed packet will be 10 bytes.

| Field Size: | Description: |
|---|---|
| 1 byte | Packet Type = 0x80 |
| 1 byte | Packet Subtype = 0x0B |
| 2 bytes | Packet Size = 10 |
| 4 bytes | Time-out (seconds) |
| 2 bytes | CRC |

Suspend Processing Response

Sent by the communications process on a master terminal in response to a Suspend Processing request packet, indicating that the processing will be suspended as soon as possible. The client can use Get Link Status to determine when processing has been suspended. The total size of the framed packet will be 6 bytes.

| Field Size: | Description: |
|---|---|
| 1 byte | Packet Type = 0x80 |
| 1 byte | Packet Subtype = 0x0C |
| 2 bytes | Packet Size = 6 |
| 2 bytes | CRC |

Resume Processing

Informs the communications process on a master terminal that normal processing can be resumed. This should be performed after a time-critical operation has completed, and should balance each Suspend Processing packet. The total size of the framed packet will be 6 bytes.

| Field Size: | Description: |
|---|---|
| 1 byte | Packet Type = 0x80 |
| 1 byte | Packet Subtype = 0x0D |
| 2 bytes | Packet Size = 6 |
| 2 bytes | CRC |

Resume Processing Response

Sent by the communications process on a master terminal in response to a Resume Processing request packet, indicating that normal processing will be resumed. The total size of the framed packet will be 6 bytes.

| Field Size: | Description: |
|---|---|
| 1 byte | Packet Type = 0x80 |
| 1 byte | Packet Subtype = 0x0E |
| 2 bytes | Packet Size = 6 |
| 2 bytes | CRC |

Synchronize

Requests that the communications process on a master terminal initiate a synchronization with its server. Different levels of synchronization can be requested in the flags field. Note that the communications process should perform a full synchronization on startup and again every few hours automatically (depending on the dialing interval configured for the location). The total size of the framed packet will be 7 bytes.

| Field Size: | Description: |
|---|---|
| 1 byte | Packet Type = 0x80 |
| 1 byte | Packet Subtype = 0x0F |
| 2 bytes | Packet Size = 7 |
| 1 byte | Flags |
| | Defined bits include: |

| | |
|---|---|
| 0x01 | Scan file system and update |
| | W_CON- |
| | TENT_CACHE table |
| 0x02 | Synchronize the database |
| | with the server |
| 0x04 | Synchronize subscriber |
| | records in cache |
| 0xFF | Do full synchronization |

| | |
|---|---|
| 2 bytes | CRC |

Synchronize Response

Sent by the communications process on the master terminal in response to a Synchronize packet, indicating that the process will begin the synchronization as soon as possible. The total size of the framed packet will be 6 bytes.

| Field Size: | Description: |
|---|---|
| 1 byte | Packet Type = 0x80 |
| 1 byte | Packet Subtype = 0x10 |
| 2 bytes | Packet Size = 6 |
| 2 bytes | CRC |

For the synchronization function, assuming that the inventory of a subscriber is being downloaded, e.g. from a database associated with a regional server to a database associated with an arcade, public PC or validation and redemption terminal, the packets can add a field (e.g. 4 bytes) which identifies the subscriber.

The administration terminal 43 contains a database which specifies the entire system, in subdatabases which can be specified as classes. The content of the complete database, or the content of each subdatabase can be specified by a single administration entity, or any can be specified by authorized suppliers. In the latter case, the content of the subdatabases can be filled by communication between the terminal 43 and suppliers' terminals, using the system shown in FIG. 1.

Subdatabases are preferred to relate to the following:

| | |
|---|---|
| Suppliers | Locations |
| Game Machines | Game Software |
| Redemptions | Tournaments |
| Merchandise Categories | Pricing |
| Prizes | Alarms |
| Schedules | Manufacturers |
| Subscribers | Technicians |
| Advertising | Content |
| Coupons | Loyalty Programs |
| Promotions | Services |
| Profile Descriptor | |
| (e.g. VALs) | |

VAL™ is a standard profile descriptor which has been adopted by some companies. VALs or class systems used by other companies can be stored and used in addition to or as a replacement for the demographic classification described herein.

Game Software is an example of the above. A field of the above can be the identification of a game which is located on a CD ROM, hard disk drive DVD or mass semiconductor or other storage means at a game location. Another field can be an algorithm which controls the parameters of the game. Another field can store score brackets which a player must reach in order to win a prize. Another field can store timing information which can be used to modify the brackets. Other fields can be filled with other data required for the game.

The other subdatabases can be similarly filled with data to specify the operation of each parameter of the system. For example, a merchant can specify a premium related to the merchant's store as a prize to the player of a game at an arcade nearby to the store. A field in the prize or coupon subdatabase can point to the game or games for which the premium or coupon is to be distributed, another can specify a score bracket to be achieved (which can be >0) by the player in order to win the premium or coupon, etc.

Once the database has been completed to a required level, the subdatabases are downloaded to the decision support server 7, which stores it in its database 9. The decision support server then downloads the data as related to the various peripheral terminals to the associated regional servers, which in turn stores required data in their respective databases 5A to 5N, and downloads the data related to the respective terminals to those of concern.

For example, regional server 5A downloads initialization parameters to the master games 21 in the arcades in, which authorized game machines are located which can communicate with the regional server 5A. It also downloads initialization parameters to the software at the public PCS with which it can communicate, which have been authorized at the administration location.

As a further example, the initialization parameters may initialize or authorize operation of particular video games, with particular score brackets, at the arcade 17 and at the public PC. The initialization parameters may also initialize a program at the public PC which controls acceptance of payments, and/or acceptance of orders for merchandise, and/or redemption of premiums, etc., and also controls transmission of data to the regional server which updates the account of the customer in currency or other media of exchange such as loyalty points, etc.

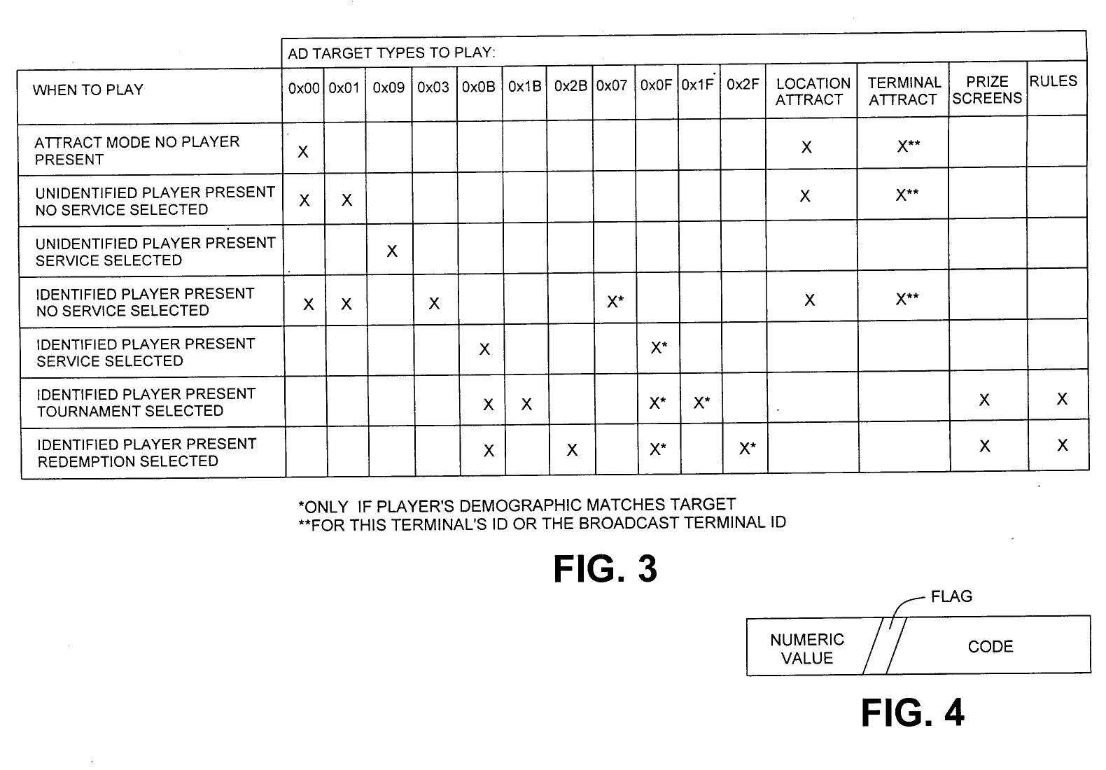

A key aspect of the system is to control the advertising shown to specific subscribers. Advertising can be shown in “slots”, e.g. frames on a video game or public PC display. The administrator can specify advertisement types as indicated in the matrix of FIG. 3 as “Ad Target Types to Play”, i.e. types of ads for specific matched demographic player types. The first column in the matrix specifies “When To Play”.

For example, when no player is present, advertisement types “0×00” followed by “Location Attract”, followed by “Terminal Attract (for this terminal's ID or a broadcast ID)” are specified. When an unidentified player is present (e.g. by detecting a body using an infrared detector), but no service has been selected, an additional advertisement “0×01” is run immediately following advertisement “0×00”.

The entire matrix is filled out at an administrative location and is stored at the administration terminal 43 database, and once complete, it is downloaded to the decision support server 7, and stored in its database 9. It is then downloaded to the regional server, where it is stored in database 5A, and is downloaded to the master game 21, where it is stored in database 23.

The master game 21 then controls the local DVD or CD ROM in accordance with the local condition (when to play), to run the advertisements identified in the matrix.

One of the parameters that can be used in an advertisement subdatabase is a demographic limit. For example, a field parameter can specify that playing of an advertisement for a toy doll can be logically nulled in the event that the location of the game, or the location of the identified player, is in a bar. This information can be downloaded with the initialization data for an advertisement and/or for a player.

Once playing is initialized, the advertisement specified in the database matrix or the equivalent stored at the database 23 of the master game 21 is indicated to the game shell to be loaded from the DVD or CD ROM. The game shell inserts the advertisement into a time slot and window (or full screen) on the game (or public PC or other form of) display. Unless the presence of a player, identified or not, has been detected (e.g. detected by an infrared detector, by swiping of a player's card in a card reader, by detection of a bar code of a coupon or premium by a bar code reader at a validation and redemption center, or by detection of a personal characteristic such as handwriting, voice, fingerprint, palmprint, iris, etc.) once display of the advertisement has been completed, the master game (or public PC) software accesses the database matrix or the equivalent and causes the next advertisement to run via the shell and be displayed.

In the event the presence of a subscriber, or of an identified subscriber, is detected, the master game (or public PC) software accesses the advertisement matrix in the database 23, and determines that a different schedule of advertisements should be run. It then indicates which is the first of the advertisements in this schedule, and causes it to run via the shell, as described above.

It will be recognized that a player will typically interrupt an attraction mode advertisement by indicating that he wishes to play a game, e.g. by swiping his card in the card reader of a game, or by depositing coins in the coin acceptor of the-game and keying in an identification code. The game software will then indicate this to the master game, which stores an indication in the indicated subscriber's database the identity of the last complete advertisement that the subscriber has seen. This is stored in the table “SUBSCRIBER_AD”, under “AD_ID” (See Table 1 located at the end of this specification). When the subscriber is next indicated as being present at a viewable location, and is not playing a game, the next advertisement in the sequence indicated on the matrix is controlled by the master game or public PC to be displayed.

It will be noted from Table 1 that the record: table=“Ad_Target” contains fields which specify the minimum and maximum daily exposures, and the minimum and total daily exposures of an advertisement. These values can be based on sales of the advertisement, and are specified by the administrator.

Considering the tables of the database relating to the advertising, in the table AD,

the first field RECORD_ID stores the record number,

the field AD_ID stores the identity of the advertisement,

the field CONTENT_ID identifies the file(s) that make up the advertisement (video clips, audio, image, etc.),

the field PRECEDING_AD_ID identifies the advertisement to be run immediately preceding this one,

the field NEXT_AD_ID identifies the advertisement to be run immediately following this one,

the field MAX_VIEWS_PER_PERSON specifies the maximum number of times the present advertisement should be shown to an identified subscriber,

the field FLAGS can be used to for various purposes, such as inhibiting a specified ad from playing, e.g. inhibiting plays from bars, casinos, arcades, general audiences, men, women, male teens, female teens, etc.

With the above detailed explanation of the first table, the remaining tables (records) and fields are believed to be self-explanatory from the names given to the tables and to each of the fields.

It should also be noted that advertisements can be selected based on an algorithm. For example, a random number (e.g. between 0 and 9, say 5) can be obtained from a random number generator. That random number 5 can identify e.g. a video or slide advertisement to be run. Following running, that random number can be added to another predetermined number (e.g. 3), to identify the next advertisement to be run, e.g. advertisement number 8. Following running of advertisement number 8, that number can be added to another predetermined number (e.g. 7), to identify the next advertisement to be run, e.g. advertisement number 15, etc. The selection of which advertisement to run can cycle back to the beginning, or once a predetermined highest number has been reached, another random number can be selected and the process started again.

It may be seen that the identity of advertisements that are selected for playing have been filtered through a schedule of particular advertisements. It is preferred that they should also be filtered by exclusions, for unsuitable advertisements. For example, cigarette advertisements or advertisements containing unsuitable subject matter can be excluded from certain locations or excluded from certain classes of viewer based on identity-of a viewer or classes of viewer expected to be at the locations, and competitor's products can be excluded from certain locations. These exclusions (URCs) can be stored in the table=AD_URC.

The field RECORD_ID in this table stores the record identity. The field AD_ID stores the identity of the advertisement against which the URC is to be applied. The URC can be comprised of a data field illustrated in FIG. 4.

The numeric value indicates the URC restriction code number. The bit in the flag indicates IS or NO, depending on whether it is set or not. The code (e.g. the number 1, 2, etc.) indicates the restriction. For example, the code 1 can mean “underage”. Thus for example, if the advertisement indicated in the field AD_ID in the table AD_URC is unsuitable for a person under the age of 19, the flag is set (i.e. indicates IS). If an underage person such as age 17 years (as can be indicated by his identity on e.g. the swipe card and his age statistic taken when the subscriber is first registered) is indicated as being at a particular location by him swiping his card at a validation and redemption center, a public PC or at a game in an arcade, for example, the advertisement is filtered through the URC, and is not shown for a time period. The time period can be a predetermined interval, or until a game played by the subscriber has been terminated, or can last for a time following termination of the game.

It will be recognized that rather than advertisements, messages of any type can be provided for presentation to a person, and the URCs described above are equally applicable against such messages. In this specification, the term advertisements should thus be construed to include messages of any type, and presented in any way, such as by still picture, video, audio, etc. The term display should also be construed to include any form of presentation, including audio, video, tactile, odour dispersion, etc.

It should be noted that while the description herein is to a client-server type system which communicate in a particular manner, the equivalent function and structure of the invention could also be realized by persons skilled in the art understanding this invention via one or more browsers which interface one or more web pages, either via the internet or on one or more intranets which are either self-contained or which communicate via the internet, or via private network.

A person understanding this invention may now conceive of alternate embodiments and enhancements using the principles described herein. All such embodiments and enhancements are considered to be within the spirit and scope of this invention as defined in the claims appended hereto.

TABLE 1
# initdb.ini
#
# NOTES:

| | |
|---|---|
| # 1. | Database name cannot exceed 23 characters |
| # 2. | Allowed data type are LONG, SHORT, BIN, VARBIN |
| # 3. | Table names cannot exceed 23 characters |
| # 4. | Field names cannot exceed 23 characters |
| # 5. | Arrays of SHORT and LONG are not supported (set size = 1) |
| # 6. | Variable binary fields as primary keys is not supported |
| # 7. | Each table can have only one variable binary field |
| # 8. | Variable binary field must be last field in table |
| # 9. | Variable binary field must be preceded by SHORT size field |
| # 10. | File created will be database name with “.db” appended |
| # 11. | Tables cannot exceed 32 fields |

| | | | |
|---|---|---|---|
| DATABASE = nani | | | |
| TABLE = AD | | | |
| FIELD = RECORD_ID | : BIN | : 6 | : PK |
| FIELD = AD_ID | : LONG | : 1 | |
| FIELD = CONTENT_ID | : LONG | : 1 | |
| FIELD = PRECEDING_AD_ID | : LONG | : 1 | |
| FIELD = NEXT_AD_ID | : LONG | : 1 | |
| FIELD = MAX_VIEWS_PER_PERSON | : SHORT | : 1 | |
| FIELD = FLAGS | : BIN | : 1 | |
| TABLE = AD_SCHEDULE | | | |
| FIELD = RECORD_ID | : BIN | : 6 | : PK |
| FIELD = AD_ID | : LONG | : 1 | |
| FIELD = TERMINAL_ID | : BIN | : 6 | |
| FIELD = SCHEDULE_ID | : LONG | : 1 | |
| FIELD = FLAGS | : BIN | : 1 | |
| TABLE = AD_TARGET | | | |
| FIELD = RECORD_ID | : BIN | : 6 | : PK |
| FIELD = TARGET_ID | : LONG | : 1 | |
| FIELD = AD_ID | : LONG | : 1 | |
| FIELD = TARGET_TYPE | : BIN | : 1 | |
| FIELD = TARGET_EVENT_ID | : LONG | : 1 | |
| FIELD = TARGET_SERVICE_ID | : LONG | : 1 | |
| FIELD = SLOT | : BIN | : 1 | |
| FIELD = PRIORITY | : BIN | : 1 | |
| FIELD = MIN_DAILY_EXPOSURES | : SHORT | : 1 | |
| FIELD = MAX_DAILY_EXPOSURES | : SHORT | : 1 | |
| FIELD = MIN_TOTAL_EXPOSURES | : LONG | : 1 | |
| FIELD = MAX_TOTAL_EXPOSURES | : LONG | : 1 | |
| FIELD = FLAGS | : BIN | : 1 | |
| TABLE = AD_TARGET_DEMOGRAPHIC | | | |
| FIELD = RECORD_ID | : BIN | : 6 | : PK |
| FIELD = TARGET_ID | : LONG | : 1 | |
| FIELD = DEMOGRAPHIC | : LONG | : 1 | |
| FIELD = FLAGS | : BIN | : 1 | |
| TABLE = AD TARGET_PROMOTION | | | |
| FIELD = RECORD_ID | : BIN | : 6 | : PK |
| FIELD = TARGET_ID | : LONG | : 1 | |
| FIELD = PROMOTION_ID | : LONG | : 1 | |
| FIELD = FLAGS | : BIN | : 1 | |
| TABLE = AD_URC | | | |
| FIELD = RECORD_ID | : BIN | : 6 | : PK |
| FIELD = AD_ID | : LONG | : 1 | |
| FIELD = URC | : LONG | : 1 | |
| FIELD = FLAGS | : BIN | : 1 | |
| TABLE = ALARM_HANDLER | | | |
| FIELD = RECORD_ID | : BIN | : 6 | : PK |
| FIELD = HANDLER_ID | : LONG | : 1 | |
| FIELD = ALARM_CODE | : BIN | : 1 | |
| FIELD = PRIORITY | : BIN | : 1 | |
| FIELD = PROCESS_TYPE | : BIN | : 1 | |
| FIELD = FLAGS | : BIN | : 1 | |
| FIELD = PROCESS_DATA_SIZE | : SHORT | : 1 | |
| FIELD = PROCESS_DATA | : VARBIN | : 1 | |
| TABLE = BRACKET | | | |
| FIELD = RECORD_ID | : BIN | : 6 | : PK |
| FIELD = TOURNAMENT_ID | : LONG | : 1 | |
| FIELD = BRACKET_ID | : BIN | : 1 | |
| FIELD = SHORT_NAME | : BIN | : 28 | |
| FIELD = NAME | : BIN | : 72 | |
| FIELD = START_DATE_TIME | : LONG | : 1 | |
| FIELD = END_DATE_TIME | : LONG | : 1 | |
| FIELD = SCORE_POSTING_TIME | : LONG | : 1 | |
| FIELD = ENTRY_PRICE | : LONG | : 1 | |
| FIELD = PREPAID_PLAYS | : SHORT | : 1 | |
| FIELD = MIN_GAMES_PER_PLAYER | : SHORT | : 1 | |
| FIELD = MAX_GAMES_PER_PLAYER | : SHORT | : 1 | |
| FIELD = MIN_GAMES_PER_TEAM | : SHORT | : 1 | |
| FIELD = MAX_GAMES_PER_TEAM | : SHORT | : 1 | |
| FIELD = LEADERBOARD_ID | : LONG | : 1 | |
| FIELD = SPONSER | : BIN | : 40 | |
| FIELD = ICON | : LONG | : 1 | |
| FIELD = SPLASH_SCREEN | : LONG | : 1 | |
| FIELD = FLAGS | : BIN | : 1 | |
| FIELD = RANKING_ALGORITHM | : BIN | : 1 | |
| TABLE = BRACKET_ADVANCE | | | |
| FIELD = RECORD_ID | : BIN | : 6 | : PK |
| FIELD = TOURNAMENT_ID | : LONG | : 1 | |
| FIELD = BRACKET_ID | : BIN | : 1 | |
| FIELD = ADVANCE_TYPE | : BIN | : 1 | |
| FIELD = FROM_TOURNAMENT_ID | : LONG | : 1 | |
| FIELD = FROM_BRACKET_ID | : BIN | : 1 | |
| FIELD = FROM_LOW | : LONG | : 1 | |
| FIELD = TO_HIGH | : LONG | : 1 | |
| FIELD = SERVICE_ID | : LONG | : 1 | |
| FIELD = PROFILE | : BIN | : 1 | |
| FIELD = FLAGS | : BIN | : 1 | |
| TABLE = BRACKET_MEMBERSHIP | | | |
| FIELD = RECORD_ID | : BIN | : 6 | : PK |
| FIELD = TOURNAMENT_ID | : LONG | : 1 | |
| FIELD = BRACKET_ID | : BIN | : 1 | |
| FIELD = SUBSCRIBER_ID | : LONG | : 1 | |
| FIELD = FLAGS | : BIN | : 1 | |
| TABLE = BRACKET_PRIZE | | | |
| FIELD = RECORD_ID | : BIN | : 6 | : PK |
| FIELD = TOURNAMENT_ID | : LONG | : 1 | |
| FIELD = BRACKET_ID | : BIN | : 1 | |
| FIELD = PRIZE_ITEM_ID | : LONG | : 1 | |
| FIELD = PRIZE_PERCENT_OF_POOL | : BIN | : 1 | |
| FIELD = WINNING_PLACE | : BIN | : 1 | |
| FIELD = PLACE_NAME | : BIN | : 20 | |
| FIELD = NUM_WINNERS | : LONG | : 1 | |
| FIELD = EXPIRATION_DATE | : LONG | : 1 | |
| FIELD = FLAGS | : BIN | : 1 | |
| TABLE = BRACKET_PROMOTION | | | |
| FIELD = RECORD_ID | : BIN | : 6 | : PK |
| FIELD = TOURNAMENT_ID | : LONG | : 1 | |
| FIELD = BRACKET_ID | : BIN | : 1 | |
| FIELD = PROMOTION_ID | : LONG | : 1 | |
| FIELD = FLAGS | : BIN | : 1 | |
| FIELD = MIN_RANK | : SHORT | : 1 | |
| TABLE = BRACKET_RULE_SCREEN | | | |
| FIELD = RECORD_ID | : BIN | : 6 | : PK |
| FIELD = TOURNAMENT_ID | : LONG | : 1 | |
| FIELD = BRACKET_ID | : BIN | : 1 | |
| FIELD = SERVICE_ID | : LONG | : 1 | |
| FIELD = SCREEN_INDEX | : BIN | : 1 | |
| FIELD = CONTENT_ID | : LONG | : 1 | |
| FIELD = FLAGS | : BIN | : 1 | |
| TABLE = BRACKET_SCHEDULE | | | |
| FIELD = RECORD_ID | : BIN | : 6 | : PK |
| FIELD = TOURNAMENT_ID | : LONG | : 1 | |
| FIELD = BRACKET_ID | : BIN | : 1 | |
| FIELD = TERMINAL _ID | : BIN | : 6 | |
| FIELD = SCHEDULE_ID | : LONG | : 1 | |
| FIELD = FLAGS | : BIN | : 1 | |
| FIELD = NUM_LOCAL_LEADERS | : SHORT | : 1 | |
| TABLE = BRACKET_SERVICE | | | |
| FIELD = RECORD_ID | : BIN | : 6 | : PK |
| FIELD = TOURNAMENT_ID | : LONG | : 1 | |
| FIELD = BRACKET_ID | : BIN | : 1 | |
| FIELD = SERVICE_ID | : LONG | : 1 | |
| FIELD = PROFILE | : BIN | : 1 | |
| FIELD = PRICING_ID | : LONG | : 1 | |
| FIELD = FLAGS | : BIN | : 1 | |
| FIELD = MIN_RATING_ALLOWED | : BIN | : 1 | |
| FIELD = MAX_RATING_ALLOWED | : BIN | : 1 | |
| TABLE = CATALOG_CATEGORY | | | |
| FIELD = RECORD_ID | : BIN | : 6 | : PK |
| FIELD = CATEGORY_ID | : LONG | : 1 | |
| FIELD = CATEGORY_NAME | : BIN | : 40 | |
| FIELD = PARENT_CATEGORY_ID | : LONG | : 1 | |
| FIELD = ICON | : LONG | : 1 | |
| FIELD = FLAGS | : BIN | : 1 | |
| TABLE = CATALOG_CATEGORY_URC | | | |
| FIELD = RECORD_ID | : BIN | : 6 | : PK |
| FIELD = CATEGORY_ID | : LONG | : 1 | |
| FIELD = URC | : LONG | : 1 | |
| FIELD = FLAGS | : BIN | : 1 | |
| TABLE = CONTENT | | | |
| FIELD = RECORD_ID | : BIN | : 6 | : PK |
| FIELD = CONTENT_ID | : LONG | : 1 | |
| FIELD = FORMAT | : BIN | : 1 | |
| FIELD = DURATION_MS | : LONG | : 1 | |
| FIELD = PATHNAME | : BIN | : 60 | |
| FIELD = FILE_SIZE | : LONG | : 1 | |
| FIELD = CRC | : SHORT | : 1 | |
| FIELD = FILE_TIMESTAMP | : LONG | : 1 | |
| FIELD = FLAGS | : BIN | : 1 | |
| TABLE = COUPON | | | |
| FIELD = RECORD_ID | : BIN | : 6 | |
| FIELD = COUPON_ID | : LONG | : 1 | |
| FIELD = DESCRIPTION | : BIN | : 40 | |
| FIELD = CONTENT_ID | : LONG | : 1 | |
| FIELD = UPC_SYMBOL | : BIN | : 12 | |
| FIELD = FACE_VALUE | : LONG | : 1 | |
| FIELD = MAX_ISSUED_PER_PLAYER | : SHORT | : 1 | |
| FIELD = FLAGS | : BIN | : 1 | |
| TABLE = COUPON_ITEM_SCHEDULE | | | |
| FIELD = RECORD_ID | : BIN | : 6 | : PK |
| FIELD = COUPON_ID | : LONG | : 1 | |
| FIELD = ITEM_ID | : LONG | : 1 | |
| FIELD = TERMINAL_ID | : BIN | : 6 | |
| FIELD = SCHEDULE_ID | : LONG | : 1 | |
| FIELD = COUPON_CASH_VALUE | : LONG | : 1 | |
| FIELD = COUPON_PRICE | : LONG | : 1 | |
| FIELD = NUM_ITEMS_PER_COUPON | : SHORT | : 1 | |
| FIELD = MAX_REDEEMED | : SHORT | : 1 | |
| FIELD = FLAGS | : BIN | : 1 | |
| TABLE = COUPON_SERV- | | | |
| ICE_SCHEDULE | | | |
| FIELD = RECORD_ID | : BIN | : 6 | : PK |
| FIELD = COUPON_ID | : LONG | : 1 | |
| FIELD = SERVICE_ID | : LONG | : 1 | |
| FIELD = TERMINAL_ID | : BIN | : 6 | |
| FIELD = SCHEDULE_ID | : LONG | : 1 | |
| FIELD = COUPON_CASH_VALUE | : LONG | : 1 | |
| FIELD = COUPON_PRICE | : LONG | : 1 | |
| FIELD = NUM_PLAYS_PER_COUPON | : SHORT | : 1 | |
| FIELD = MAX_REDEEMED | : SHORT | : 1 | |
| FIELD = FLAGS | : BIN | : 1 | |
| TABLE = FILE_INFO | | | |
| FIELD = RECORD_ID | : BIN | : 6 | : PK |
| FIELD = FILE_ID | : LONG | : 1 | |
| FIELD = FILESET_ID | : LONG | : 1 | |
| FIELD = PATHNAME | : BIN | : 60 | |
| FIELD = FILE_SIZE | : LONG | : 1 | |
| FIELD = CRC | : SHORT | : 1 | |
| FIELD = FILE_TIMESTAMP | : LONG | : 1 | |
| FIELD = FLAGS | : BIN | : 1 | |
| TABLE = ITEM | | | |
| FIELD = RECORD_ID | : BIN | : 6 | : PK |
| FIELD = ITEM_ID | : LONG | : 1 | |
| FIELD = CATEGORY_ID | : LONG | : 1 | |
| FIELD = ITEM_NAME | : BIN | : 40 | |
| FIELD = MIN_PRICE | : LONG | : 1 | |
| FIELD = MAX_PRICE | : LONG | : 1 | |
| FIELD = ICON | : LONG | : 1 | |
| FIELD = FLAGS | : BIN | : 1 | |
| FIELD = ITEM_COST | : LONG | : 1 | |
| FIELD = RETAIL_PRICE | : LONG | : 1 | |
| FIELD = QUANTITY_ON_HAND | : LONG | : 1 | |
| FIELD = MIN_QUANTITY_ON_HAND | : LONG | : 1 | |
| FIELD = DISTRIBUTION_LOCATION | : BIN | : 40 | |
| TABLE = ITEM_ATTRIBUTE | | | |
| FIELD = RECORD_ID | : BIN | : 6 | : PK |
| FIELD = ITEM_ID | : LONG | : 1 | |
| FIELD = ATTRIBUTE_ID | : BIN | : 1 | |
| FIELD = ATTRIBUTE_NAME | : BIN | : 40 | |
| FIELD = DATA_TYPE | : BIN | : 1 | |
| FIELD = MINIMUM | : LONG | : 1 | |
| FIELD = MAXIMUM | : LONG | : 1 | |
| FIELD = FLAGS | : BIN | : 1 | |
| TABLE = ITEM_ATTRIBUTE_VALUE | | | |
| FIELD = RECORD_ID | : BIN | : 6 | : PK |
| FIELD = ITEM_ID | : LONG | : 1 | |
| FIELD = ATTRIBUTE_ID | : BIN | : 1 | |
| FIELD = VALUE_INDEX | : BIN | : 1 | |
| FIELD = VALUE_TEXT | : BIN | : 30 | |
| FIELD = FLAGS | : BIN | : 1 | |
| TABLE = ITEM_PROMOTION | | | |
| FIELD = RECORD_ID | : BIN | : 6 | : PK |
| FIELD = ITEM_ID | : LONG | : 1 | |
| FIELD = PROMOTION_ID | : LONG | : 1 | |
| FIELD = FLAGS | : BIN | : 1 | |
| TABLE = ITEM_SCHEDULE | | | |
| FIELD = RECORD_ID | : BIN | : 6 | : PK |
| FIELD = ITEM_ID | : LONG | : 1 | |
| FIELD = TERMINAL_ID | : BIN | : 6 | |
| FIELD = SCHEDULE_ID | : LONG | : 1 | |
| FIELD = FLAGS | : BIN | : 1 | |
| TABLE = ITEM_SCREEN | | | |
| FIELD = RECORD_ID | : BIN | : 6 | : PK |
| FIELD = ITEM_ID | : LONG | : 1 | |
| FIELD = SCREEN_INDEX | : BIN | : 1 | |
| FIELD = CONTENT_ID | : LONG | : 1 | |
| FIELD = FLAGS | : BIN | : 1 | |
| TABLE = ITEM_URC | | | |
| FIELD = RECORD_ID | : BIN | : 6 | : PK |
| FIELD = ITEM_ID | : LONG | : 1 | |
| FIELD = URC | : LONG | : 1 | |
| FIELD = FLAGS | : BIN | : 1 | |
| TABLE = LEADERBOARD | | | |
| FIELD = RECORD_ID | : BIN | : 6 | : PK |
| FIELD = LEADERBOARD_ID | : LONG | : 1 | |
| FIELD = LEADERBOARD_DATE_TIME | : LONG | : 1 | |
| FIELD = FLAGS | : BIN | : 1 | |
| FIELD = MAX_LEADERS | : SHORT | : 1 | |
| TABLE = LEADERBOARD_LEADER | | | |
| FIELD = RECORD_ID | : BIN | : 6 | : PK |
| FIELD = LEADERBOARD_ID | : LONG | : 1 | |
| FIELD = SUBSCRIBER_ID | : LONG | : 1 | |
| FIELD = ALIAS | : BIN | : 26 | |
| FIELD = LOCATION_NAME | : BIN | : 26 | |
| FIELD = LOCATION_CITY_STATE | : BIN | : 26 | |
| FIELD = PRIZE_NAME | : BIN | : 26 | |
| FIELD = SCORE | : LONG | : 1 | |
| FIELD = SCORE_DATE_TIME | : LONG | : 1 | |
| FIELD = FLAGS | : BIN | : 1 | |
| TABLE = LEADERBOARD_RANKING | | | |
| FIELD = RECORD_ID | : BIN | : 6 | : PK |
| FIELD = LEADERBOARD_ID | : LONG | : 1 | |
| FIELD = RANK | : SHORT | : 1 | |
| FIELD = SUBSCRIBER_ID | : LONG | : 1 | |
| FIELD = FLAGS | : BIN | : 1 | |
| TABLE = LOCATION | | | |
| FIELD = RECORD_ID | : BIN | : 6 | : PK |
| FIELD = LOCATION_ID | : LONG | : 1 | |
| FIELD = SHORT_NAME | : BIN | : 26 | |
| FIELD = NAME | : BIN | : 72 | |
| FIELD = SHORT_CITY_STATE | : BIN | : 26 | |
| FIELD = CITY_STATE | : BIN | : 72 | |
| FIELD = TIME_ZONE | : BIN | : 1 | |
| FIELD = MAX_DAILY_PAYOUT | : LONG | : 1 | |
| FIELD = DIALIN_INTERVAL | : LONG | : 1 | |
| FIELD = LANGUAGE_CODE | : SHORT | : 1 | |
| FIELD = COUNTRY_CODE | : SHORT | : 1 | |
| FIELD = FLAGS | : BIN | : 1 | |
| FIELD = TOKEN_PRICE | : LONG | : 1 | |
| TABLE = LOCATION_AT- | | | |
| TRACT_SCREEN | | | |
| FIELD = RECORD_ID | : BIN | : 6 | : PK |
| FIELD = LOCATION_ID | : LONG | : 1 | |
| FIELD = SCREEN_INDEX | : BIN | : 1 | |
| FIELD = CONTENT_ID | : LONG | : 1 | |
| FIELD = FLAGS | : BIN | : 1 | |
| TABLE = LOCATION_COUPON_SCHED | | | |
| FIELD = RECORD_ID | : BIN | : 6 | : PK |
| FIELD = LOCATION_ID | : LONG | : 1 | |
| FIELD = COUPON_ID | : LONG | : 1 | |
| FIELD = SCHEDULE_ID | : LONG | : 1 | |
| FIELD = COUPON_PRICE | : LONG | : 1 | |
| FIELD = FLAGS | : BIN | : 1 | |
| TABLE = LOCATION_LOYALTY_SCHED | | | |
| FIELD = RECORD_ID | : BIN | : 6 | : PK |
| FIELD = LOCATION_ID | : LONG | : 1 | |
| FIELD = LOYALTY_PROGRAM_ID | : LONG | : 1 | |
| FIELD = SCHEDULE_ID | : LONG | : 1 | |
| FIELD = POINT_PRICE | : LONG | : 1 | |
| FIELD = FLAGS | : BIN | : 1 | |
| TABLE = LOCATION_URC | | | |
| FIELD = RECORD_ID | : BIN | : 6 | : PK |
| FIELD = LOCATION_ID | : LONG | : 1 | |
| FIELD = URC | : LONG | : 1 | |
| FIELD = FLAGS | : BIN | : 1 | |
| TABLE = LOYALTY_PROGRAM | | | |
| FIELD = RECORD_ID | : BIN | : 6 | |
| FIELD = LOYALTY_PROGRAM_ID | : LONG | : 1 | |
| FIELD = NAME | : BIN | : 40 | |
| FIELD = POINT_LABEL | : BIN | : 20 | |
| FIELD = FLAGS | : BIN | : 1 | |
| TABLE = LOYALTY_ITEM_SCHED | | | |
| FIELD = RECORD_ID | : BIN | : 6 | : PK |
| FIELD = LOYALTY_PROGPAM_ID | : LONG | : 1 | |
| FIELD = ITEM_ID | : LONG | : 1 | |
| FIELD = TERMINAL_ID | : BIN | : 6 | |
| FIELD = SCHEDULE_ID | : LONG | : 1 | |
| FIELD = POINT_CASH_VALUE | : LONG | : 1 | |
| FIELD = POINT_PRICE | : LONG | : 1 | |
| FIELD = POINT_PER_ITEM | : SHORT | : 1 | |
| FIELD = ITEMS_PER_POINT | : SHORT | : 1 | |
| FIELD = MAX_USED_PER_ITEM | : SHORT | : 1 | |
| FIELD = FLAGS | : BIN | : 1 | |
| TABLE = LOYALTY_SERVICE_SCHED | | | |
| FIELD = RECORD_ID | : BIN | : 6 | : PK |
| FIELD = LOYALTY_PROGRAM_ID | : LONG | : 1 | |
| FIELD = SERVICE_ID | : LONG | : 1 | |
| FIELD = TERMINAL_ID | : BIN | : 6 | |
| FIELD = SCHEDULE_ID | : LONG | : 1 | |
| FIELD = POINT_CASH_VALUE | : LONG | : 1 | |
| FIELD = POINT_PRICE | : LONG | : 1 | |
| FIELD = POINTS_PER_PLAY | : SHORT | : 1 | |
| FIELD = PLAYS_PER_POINT | : SHORT | : 1 | |
| FIELD = MAX_USED_PER_PLAY | : SHORT | : 1 | |
| FIELD = FLAGS | : BIN | : 1 | |
| TABLE = PRICING | | | |
| FIELD = RECORD_ID | : BIN | : 6 | : PK |
| FIELD = PRICING_ID | : LONG | : 1 | |
| FIELD = PRICE_TO_START | : LONG | : 1 | |
| FIELD = PRICE_TO_CONTINUE | : LONG | : 1 | |
| FIELD = START_DURATION | : LONG | : 1 | |
| FIELD = CONTINUE_DURATION | : LONG | : 1 | |
| FIELD = FLAGS | : BIN | : 1 | |
| TABLE = PROMOTION | | | |
| FIELD = RECORD_ID | : BIN | : 6 | : PK |
| FIELD = PROMOTION_ID | : LONG | : 1 | |
| FIELD = FLAGS | : BIN | : 1 | |
| TABLE = PROMOTION_COUPON | | | |
| FIELD = RECORD_ID | : BIN | : 6 | : PK |
| FIELD = PROMOTION_ID | : LONG | : 1 | |
| FIELD = COUPON_ID_TO_AWARD | : LONG | : 1 | |
| FIELD = FLAGS | : BIN | : 1 | |
| TABLE = PROMOTION_LOYALTY | | | |
| FIELD = RECORD_ID | : BIN | : 6 | : PK |
| FIELD = PROMOTION_ID | : LONG | : 1 | |
| FIELD = LOYALTY_PROGRAM_ID | : LONG | : 1 | |
| FIELD = NUM_POINTS_TO_AWARD | : SHORT | : 1 | |
| FIELD = FLAGS | : BIN | : 1 | |
| TABLE = REDEMPTION | | | |
| FIELD = RECORD_ID | : BIN | : 6 | : PK |
| FIELD = REDEMPTION_ID | : LONG | : 1 | |
| FIELD = FLAGS | : BIN | : 1 | |
| FIELD = MIN_RATING_ALLOWED | : BIN | : 1 | |
| FIELD = MAX_RATING_ALLOWED | : BIN | : 1 | |
| FIELD = SERVICE_ID | : LONG | : 1 | |
| FIELD = PROFILE | : BIN | : 1 | |
| FIELD = SHORT_NAME | : BIN | : 28 | |
| FIELD = NAME | : BIN | : 72 | |
| FIELD = PRICING_ID | : LONG | : 1 | |
| FIELD = START_DATE_TIME | : LONG | : 1 | |
| FIELD = END_DATE_TIME | : LONG | : 1 | |
| FIELD = SPONSER | : BIN | : 40 | |
| FIELD = ICON | : LONG | : 1 | |
| FIELD = SPLASH_SCREEN | : LONG | : 1 | |
| FIELD = PERCENT_MONEY_TO_POOL | : BIN | : 1 | |
| FIELD = CURRENT_POOL_VALUE | : LONG | : 1 | |
| FIELD = VALUE_OF_AVAIL_PRIZES | : LONG | : 1 | |
| FIELD = PLAYS_TO_DATE | : LONG | : 1 | |
| FIELD = LAST_UPDATE_DATE_TIME | : LONG | : 1 | |
| TABLE = REDEMPTION_PAR_LEVEL | | | |
| FIELD = RECORD_ID | : BIN | : 6 | : PK |
| FIELD = REDEMPTION_ID | : LONG | : 1 | |
| FIELD = PAR_LEVEL | : BIN | : 1 | |
| FIELD = PAR_SCORE | : LONG | : 1 | |
| FIELD = TARGET_PAY_PERCENT | : BIN | : 1 | |
| FIELD = PRIZE_ITEM_ID | : LONG | : 1 | |
| FIELD = PERCENT_OF_POOL_APPLIED | : BIN | : 1 | |
| FIELD = EXPIRATION_DATE | : LONG | : 1 | |
| FIELD = NUM_REMAINING | : LONG | : 1 | |
| FIELD = NIM_WIN_INTERVAL | : LONG | : 1 | |
| FIELD = FLAGS | : BIN | : 1 | |
| FIELD = MIN_PRIOR_PLAYS | : LONG | : 1 | |
| TABLE = REDEMPTION_PROMOTION | | | |
| FIELD = RECORD_ID | : BIN | : 6 | : PK |
| FIELD = REDEMPTION_ID | : LONG | : 1 | |
| FIELD = PROMOTION_ID | : LONG | : 1 | |
| FIELD = FLAGS | : BIN | : 1 | |
| FIELD = PAR_LEVEL | : BIN | : 1 | |
| TABLE = REDEMPTION_RULE_SCREEN | | | |
| FIELD = RECORD_ID | : BIN | : 6 | : PK |
| FIELD = REDEMPTION_ID | : LONG | : 1 | |
| FIELD = SCREEN_INDEX | : BIN | : 1 | |
| FIELD = CONTENT_ID | : LONG | : 1 | |
| FIELD = FLAGS | : BIN | : 1 | |
| TABLE = REDEMPTION_SCHEDULE | | | |
| FIELD = RECORD_ID | : BIN | : 6 | : PK |
| FIELD = REDEMPTION_ID | : LONG | : 1 | |
| FIELD = TERMINAL_ID | : BIN | : 6 | |
| FIELD = SCHEDULE_ID | : LONG | : 1 | |
| FIELD = FLAGS | : BIN | : 1 | |
| TABLE = REDEMPTION_URC | | | |
| FIELD = RECORD_ID | : BIN | : 6 | : PK |
| FIELD = REDEMPTION_ID | : LONG | : 1 | |
| FIELD = URC | : LONG | : 1 | |
| FIELD = FLAGS | : BIN | : 1 | |
| TABLE = SCHEDULE | | | |
| FIELD = RECORD_ID | : BIN | : 6 | : PK |
| FIELD = SCHEDULE_ID | : LONG | : 1 | |
| FIELD = START_DATE_TIME | : LONG | : 1 | |
| FIELD = END_DATE_TIME | : LONG | : 1 | |
| FIELD = WEEKDAYS | : BIN | : 1 | |
| FIELD = START_TIME_OF_DAY | : LONG | : 1 | |
| FIELD = END_TIME_OF_DAY | : LONG | : 1 | |
| FIELD = FLAGS | : BIN | : 1 | |
| TABLE = SERVICE | | | |
| FIELD = RECORD_ID | : BIN | : 6 | : PK |
| FIELD = SERVICE_ID | : LONG | : 1 | |
| FIELD = SERVICE_TYPE | : BIN | : 1 | |
| FIELD = FLAGS | : BIN | : 1 | |
| FIELD = SHORT_NAME | : BIN | : 30 | |
| FIELD = NAME | : BIN | : 72 | |
| FIELD = ICON | : LONG | : 1 | |
| FIELD = ATTRACT_SCREEN | : LONG | : 1 | |
| FIELD = SW_CAPABILITIES | : BIN | : 10 | |
| FIELD = HW_REQUIREMENTS | : BIN | : 10 | |
| FIELD = FILESET_ID | : LONG | : 1 | |
| FIELD = EXECUTABLE_FILE_ID | : LONG | : 1 | |
| TABLE = SERVICE_PROFILE | | | |
| FIELD = RECORD_ID | : BIN | : 6 | : PK |
| FIELD = SERVICE_ID | : LONG | : 1 | |
| FIELD = PROFILE | : BIN | : 1 | |
| FIELD = PROFILE_NAME | : BIN | : 40 | |
| FIELD = FLAGS | : BIN | : 1 | |
| FIELD = SCORE_FORMULA_LENGTH | : SHORT | : 1 | |
| FIELD = SCORE_FORMULA | : VARBIN | : 1 | |
| TABLE = SERVICE_PROFILE_SETTING | | | |
| FIELD = RECORD_ID | : BIN | : 6 | : PK |
| FIELD = SERVICE_ID | : LONG | : 1 | |
| FIELD = PROFILE | : BIN | : 1 | |
| FIELD = SETTING_ID | : LONG | : 1 | |
| FIELD = SETTING_VALUE | : LONG | : 1 | |
| FIELD = FLAGS | : BIN | : 1 | |
| TABLE = SERVICE_PROMOTION | | | |
| FIELD = RECORD_ID | : BIN | : 6 | : PK |
| FIELD = SERVICE_ID | : LONG | : 1 | |
| FIELD = PROMOTION_ID | : LONG | : 1 | |
| FIELD = FLAGS | : BIN | : 1 | |
| TABLE = SERVICE_RATING | | | |
| FIELD = RECORD_ID | : BIN | : 6 | : PK |
| FIELD = SERVICE_ID | : LONG | : 1 | |
| FIELD = RATING | : BIN | : 1 | |
| FIELD = DESCRIPTION | : BIN | : 26 | |
| FIELD = FLAGS | : BIN | : 1 | |
| TABLE = SERVICE_SCHEDULE | | | |
| FIELD = RECORD_ID | : BIN | : 6 | : PK |
| FIELD = SERVICE_ID | : LONG | : 1 | |
| FIELD = TERMINAL_ID | : BIN | : 6 | |
| FIELD = SCHEDULE_ID | : LONG | : 1 | |
| FIELD = PROFILE | : BIN | : 1 | |
| FIELD = PRICING_ID | : LONG | : 1 | |
| FIELD = FLAGS | : BIN | : 1 | |
| TABLE = SERVICE_SETTING | | | |
| FIELD = RECORD_ID | : BIN | : 6 | : PK |
| FIELD = SERVICE_ID | : LONG | : 1 | |
| FIELD = SETTING_ID | : LONG | : 1 | |
| FIELD = SETTING_NAME | : BIN | : 32 | |
| FIELD = TYPE | : BIN | : 1 | |
| FIELD = FLAGS | : BIN | : 1 | |
| TABLE = SERVICE_SLOT | | | |
| FIELD = RECORD_ID | : BIN | : 6 | : PK |
| FIELD = SERVICE_ID | : LONG | : 1 | |
| FIELD = SLOT | : BIN | : 1 | |
| FIELD = SCHEDULE_ID | : LONG | : 1 | |
| FIELD = NUM_AD_PLAYS | : BIN | : 1 | |
| FIELD = FLAGS | : BIN | : 1 | |
| TABLE = SERVICE_STATISTIC | | | |
| FIELD = RECORD_ID | : BIN | : 6 | : PK |
| FIELD = SERVICE_ID | : LONG | : 1 | |
| FIELD = STATISTIC_ID | : LONG | : 1 | |
| FIELD = STATISTIC_NAME | : BIN | : 20 | |
| FIELD = LOWER_LIMIT | : LONG | : 1 | |
| FIELD = UPPER_LIMIT | : LONG | : 1 | |
| FIELD = FLAGS | : BIN | : 1 | |
| TABLE = SERVICE_TERMINAL | | | |
| FIELD = RECORD_ID | : BIN | : 6 | : PK |
| FIELD = SERVICE_ID | : LONG | : 1 | |
| FIELD = TERMINAL_ID | : BIN | : 6 | |
| FIELD = LICENSE_KEY | : BIN | : 16 | |
| FIELD = FILESET_ID | : LONG | : 1 | |
| FIELD = FLAGS | : BIN | : 1 | |
| TABLE = SERVICE_TYPE | | | |
| FIELD = RECORD_ID | : BIN | : 6 | : PK |
| FIELD = TYPE | : BIN | : 1 | |
| FIELD = PARENT_TYPE | : BIN | : 1 | |
| FIELD = TYPE_NAME | : BIN | : 16 | |
| FIELD = FLAGS | : BIN | : 1 | |
| TABLE = SERVICE_URC | | | |
| FIELD = RECORD_ID | : BIN | : 6 | : PK |
| FIELD = SERVICE_ID | : LONG | : 1 | |
| FIELD = URC | : LONG | : 1 | |
| FIELD = FLAGS | : BIN | : 1 | |
| TABLE = SUBSCRIBER | | | |
| FIELD = RECORD_ID | : BIN | : 6 | : PK |
| FIELD = SUBSCRIBER_ID | : LONG | : 1 | |
| FIELD = ALIAS | : BIN | : 26 | |
| FIELD = FIRST_NAME | : BIN | : 20 | |
| FIELD = LAST_NAME | : BIN | : 20 | |
| FIELD = MIDDLE_INITIAL | : BIN | : 2 | |
| FIELD = STREET_ADDRESS | : BIN | : 40 | |
| FIELD = POSTAL_CODE | : BIN | : 10 | |
| FIELD = PHONE_NUMBER | : BIN | : 10 | |
| FIELD = BIRTH_DAY | : BIN | : 1 | |
| FIELD = BIRTH_MONTH | : BIN | : 1 | |
| FIELD = BIRTH_YEAR | : SHORT | : 1 | |
| FIELD = GENDER | : BIN | : 1 | |
| FIELD = FLAGS | : BIN | : 1 | |
| FIELD = DEMOGRAPHIC | : LONG | : 1 | |
| FIELD = LAST_UPDATE_DATE_TIME | : LONG | : 1 | |
| TABLE = SUBSCRIBER_AD | | | |
| FIELD = RECORD_ID | : BIN | : 6 | : PK |
| FIELD = SUBSCRIBER_ID | : LONG | : 1 | |
| FIELD = AD_ID | : LONG | : 1 | |
| FIELD = VIEW_DATE_TIME | : LONG | : 1 | |
| FIELD = FLAGS | : BIN | : 1 | |
| TABLE = SUBSCRIBER_AVATAR | | | |
| FIELD = RECORD_ID | : BIN | : 6 | : PK |
| FIELD = SUBSCRIBER_ID | : LONG | : 1 | |
| FIELD = AVATAR_TYPE | : BIN | : 1 | |
| FIELD = CONTENT_ID | : LONG | : 1 | |
| FIELD = FLAGS | : BIN | : 1 | |
| TABLE = SUBSCRIBER_BRACKET | | | |
| FIELD = RECORD_ID | : BIN | : 6 | : PK |
| FIELD = SUBSCRIBER_ID | : LONG | : 1 | |
| FIELD = TOURNAMENT_ID | : LONG | : 1 | |
| FIELD = BRACKET_ID | : BIN | : 1 | |
| FIELD = GAMES_PLAYED | : SHORT | : 1 | |
| FIELD = FLAGS | : BIN | : 1 | |
| FIELD = RANK | : LONG | : 1 | |
| FIELD = RANK_DATE_TIME | : LONG | : 1 | |
| FIELD = RANK_SCORE | : LONG | : 1 | |
| FIELD = AVERAGE_SCORE | : LONG | : 1 | |
| TABLE = SUBSCRIBER_CARD | | | |
| FIELD = RECORD_ID | : BIN | : 6 | : BK |
| FIELD = SUBSCRIBER_ID | : LONG | : 1 | |
| FIELD = CARD_TYPE | : BIN | : 1 | |
| FIELD = CARD_DATA | : BIN | : 16 | |
| FIELD = FLAGS | : BIN | : 1 | |
| TABLE = SUBSCRIBER_RATING | | | |
| FIELD = RECORD_ID | : BIN | : 6 | : PK |
| FIELD = SUBSCRIBER_ID | : LONG | : 1 | |
| FIELD = SERVICE_ID | : LONG | : 1 | |
| FIELD = PROFILE | : BIN | : 1 | |
| FIELD = RATING | : BIN | : 1 | |
| FIELD = HANDICAP | : LONG | : 1 | |
| FIELD = PLAYS_TO_QUALIFY | : BIN | : 1 | |
| FIELD = FLAGS | : BIN | : 1 | |
| TABLE = SUBSCRIBER_SAVE_STATE | | | |
| FIELD = RECORD_ID | : BIN | : 6 | : PK |
| FIELD = SUBSCRIBER_ID | : LONG | : 1 | |
| FIELD = SERVICE_ID | : LONG | : 1 | |
| FIELD = SLOT_NUMBER | : BIN | : 1 | |
| FIELD = PROFILE | : BIN | : 1 | |
| FIELD = SAVE_STATE_NAME | : BIN | : 20 | |
| FIELD = DATA_FILE_ID | : LONG | : 1 | |
| FIELD = FLAGS | : BIN | : 1 | |
| TABLE = SUBSCRIBER_URC | | | |
| FIELD = RECORD_ID | : BIN | : 6 | : PK |
| FIELD = SUBSCRIBER_ID | : LONG | : 1 | |
| FIELD = URC | : LONG | : 1 | |
| FIELD = FLAGS | : BIN | : 1 | |
| TABLE = TEAM_MEMBER | | | |
| FIELD = RECORD_ID | : BIN | : 6 | : PK |
| FIELD = TEAM_SUBSCRIBER_ID | : LONG | : 1 | |
| FIELD = SUBSCRIBER_ID | : LONG | : 1 | |
| FIELD = FLAGS | : BIN | : 1 | |
| TABLE = TECHNICIAN | | | |
| FIELD = RECORD_ID | : BIN | : 6 | : PK |
| FIELD = TECHNICIAN_ID | : LONG | : 1 | |
| FIELD = NAME | : BIN | : 26 | |
| FIELD = PIN | : SHORT | : 1 | |
| FIELD = FLAGS | : BIN | : 1 | |
| TABLE = TECHNICIAN_TERMINAL | | | |
| FIELD = RECORD_ID | : BIN | : 6 | : PK |
| FIELD = TECHNICIAN_ID | : LONG | : 1 | |
| FIELD = TERMINAL_ID | : BIN | : 6 | |
| FIELD = AUTHORIZATION_FLAGS | : BIN | : 1 | |
| TABLE = TERMINAL | | | |
| FIELD = RECORD_ID | : BIN | : 6 | : PK |
| FIELD = TERMINAL_ID | : BIN | : 6 | |
| FIELD = LOCATION_ID | : LONG | : 1 | |
| FIELD = LAN_ADDRESS | : BIN | : 4 | |
| FIELD = FLAGS | : BIN | : 1 | |
| FIELD = SERIAL_NUMBER | : BIN | : 20 | |
| FIELD = HW_CAPABILITIES | : BIN | : 10 | |
| FIELD = ATTRACT_SCREEN | : LONG | : 1 | |
| FIELD = SYSTEM_FILESET_ID | : LONG | : 1 | |
| TABLE = TOURNAMENT | | | |
| FIELD = RECORD_ID | : BIN | : 6 | : PK |
| FIELD = TOURNAMENT_ID | : LONG | : 1 | |
| FIELD = SHORT_NAME | : BIN | : 28 | |
| FIELD = NAME | : BIN | : 72 | |
| FIELD = START_DATE_TIME | : LONG | : 1 | |
| FIELD = END_DATE_TIME | : LONG | : 1 | |
| FIELD = TOURNAMENT_SCOPE | : BIN | : 1 | |
| FIELD = FLAGS | : BIN | : 1 | |
| FIELD = SPONSER | : BIN | : 40 | |
| FIELD = ICON | : LONG | : 1 | |
| FIELD = SPLASH_SCREEN | : LONG | : 1 | |
| FIELD = PERCENT_MONEY_TO_POOL | : BIN | : 1 | |
| FIELD = CURRENT_POOL_VALUE | : LONG | : 1 | |
| FIELD = PLAYS_TO_DATE | : LONG | : 1 | |
| FIELD = LAST_UPDATE_DATE_TIME | : LONG | : 1 | |
| TABLE = TOURNAMENT_URC | | | |
| FIELD = RECORD_ID | : BIN | : 6 | : PK |
| FIELD = TOURNAMENT_ID | : LONG | : 1 | |
| FIELD = URC | : LONG | : 1 | |
| FIELD = FLAGS | : BIN | : 1 | |
| TABLE = URC_VALUE | | | |
| FIELD = RECORD_ID | : BIN | : 6 | : PK |
| FIELD = URC | : LONG | : 1 | |
| FIELD = RESTRICTED_STRING | : BIN | : 30 | |
| FIELD = FLAGS | : BIN | : 1 | |
| # Working tables-not replicated from EDS | | | |
| server | | | |
| TABLE = W_AD_EXPOSURE | | | |
| FIELD = RECORD_ID | : LONG | : 1 | : PK |
| FIELD = TARGET_ID | : LONG | : 1 | |
| FIELD = SUBSCRIBER _ID | : LONG | : 1 | |
| FIELD = PLAY_DATE_TIME | : LONG | : 1 | |
| TABLE = W_AD_EXPOSURE_COUNTS | | | |
| FIELD = RECORD_ID | : LONG | : 1 | : PK |
| FIELD = TARGET_ID | : LONG | : 1 | |
| FIELD = TOTAL_PLAYS_TODAY | : SHORT | : 1 | |
| FIELD = TOTAL_PLAYS_TO_DATE | : LONG | : 1 | |
| TABLE = W_CONTENT_CACHE | | | |
| FIELD = RECORD_ID | : LONG | : 1 | : PK |
| FIELD = CONTENT_ID | : LONG | : 1 | |
| FIELD = LOCAL_PATH_SIZE | : SHORT | : 1 | |
| FIELD = LOCAL_PATH | : VARBIN | : 1 | |
| TABLE = W_COUPONS_ISSUED | | | |
| FIELD = RECORD_ID | : LONG | : 1 | : PK |
| FIELD = COUPON_ID | : LONG | : 1 | |
| FIELD = RECEIPT_ID | : BIN | : 6 | |
| FIELD = TERMINAL_ID | : BIN | : 6 | |
| FIELD = SUBSCRIBER_ID | : LONG | : 1 | |
| FIELD = ISSUE_DATE_TIME | : LONG | : 1 | |
| FIELD = FLAGS | : BIN | : 1 | |
| TABLE = W_DOWN_TIME | | | |
| FIELD = RECORD_ID | : LONG | : 1 | : PK |
| FIELD = START_DATE_TIME | : LONG | : 1 | |
| FIELD = END_DATE_TIME | : LONG | : 1 | |
| FIELD = TECHNICIAN_ID | : LONG | : 1 | |
| TABLE = W_FILE_CACHE | | | |
| FIELD = RECORD_ID | : LONG | : 1 | : PK |
| FIELD = FILE_ID | : LONG | : 1 | |
| FIELD = LOCAL_PATH_SIZE | : SHORT | : 1 | |
| FIELD = LOCAL_PATH | : VARBIN | : 1 | |
| TABLE = W_LEADERBOARD | | | |
| FIELD = RECORD_ID | : LONG | : 1 | : PK |
| FIELD = LEADERBOARD_ID | : LONG | : 1 | |
| FIELD = LEADERBOARD_DATE_TIME | : LONG | : 1 | |
| FIELD = FLAGS | : BIN | : 1 | |
| FIELD = MAX_LEADERS | : SHORT | : 1 | |
| TABLE = W_LEADERBOARD_LEADER | | | |
| FIELD = RECORD_ID | : LONG | : 1 | : PK |
| FIELD = LEADERBOARD_ID | : LONG | : 1 | |
| FIELD = SUBSCRIBER_ID | : LONG | : 1 | |
| FIELD = ALIAS | : BIN | : 26 | |
| FIELD = LOCATION_NAME | : BIN | : 26 | |
| FIELD = LOCATION_CITY_STATE | : BIN | : 26 | |
| FIELD = PRIZE_NAME | : BIN | : 26 | |
| FIELD = SCORE | : LONG | : 1 | |
| FIELD = SCORE_DATE_TIME | : LONG | : 1 | |
| TABLE = W_LEADERBOARD_RANKING | | | |
| FIELD = RECORD_ID | : LONG | : 1 | : PK |
| FIELD = LEADERBOARD_ID | : LONG | : 1 | |
| FIELD = RANK | : SHORT | : 1 | |
| FIELD = SUBSCRIBER_ID | : LONG | : 1 | |
| TABLE = W_LOCAL_LEADERBOARD | | | |
| FIELD = RECORD_ID | : LONG | : 1 | : PK |
| FIELD = LEADERBOARD_ID | : LONG | : 1 | |
| FIELD = LEADERBOARD_DATE_TIME | : LONG | : 1 | |
| FIELD = MAX_LEADERS | : SHORT | : 1 | |
| TABLE = W_LOCAL_LEADER | | | |
| FIELD = RECORD_ID | : LONG | : 1 | : PK |
| FIELD = LEADERBOARD_ID | : LONG | : 1 | |
| FIELD = RANK | : SHORT | : 1 | |
| FIELD = SUBSCRIBER_ID | : LONG | : 1 | |
| FIELD = ALIAS | : BIN | : 26 | |
| FIELD = SCORE | : LONG | : 1 | |
| FIELD = SCORE_DATE_TIME | : LONG | : 1 | |
| TABLE = LOYALTY_POINT_AWARDS | | | |
| FIELD = RECORD_ID | : LONG | : 1 | : PK |
| FIELD = SUBSCRIBER_ID | : LONG | : 1 | |
| FIELD = LOYALTY_PROGRAM_ID | : LONG | : 1 | |
| FIELD = POINTS_AWARDED | : SHORT | : 1 | |
| FIELD = AWARD_DATE_TIME | : LONG | : 1 | |
| TABLE = W_QUEUE | | | |
| FIELD = RECORD_ID | : LONG | : 1 | : PK |
| FIELD = TERMINAL_ID | : BIN | : 6 | |
| FIELD = AGE | : SHORT | : 1 | |
| FIELD = QUEUE_TIME | : LONG | : 1 | |
| FIELD = EVENT_TYPE | : BIN | : 1 | |
| FIELD = EVENT_DATA_SIZE | : SHORT | : 1 | |
| FIELD = EVENT_DATA | : VARBIN | : 1 | |
| TABLE = W_REDEMPTION_HISTORY | | | |
| FIELD = RECORD_ID | : LONG | : 1 | : PK |
| FIELD = REDEMPTION_ID | : LONG | : 1 | |
| FIELD = TIMESTAMP | : LONG | : 1 | |
| FIELD = SCORE | : LONG | : 1 | |
| FIELD = PAR_LEVEL_PAID | : BIN | : 1 | |
| FIELD = SUBSCRIBER_ID | : LONG | : 1 | |
| FIELD = CASH_AMOUNT_PAID | : LONG | : 1 | |
| TABLE = W_REDEMPTION_LO- | | | |
| CAL_POOL | | | |
| FIELD = RECORD_ID | : LONG | : 1 | : PK |
| FIELD = REDEMPTION_ID | : LONG | : 1 | |
| FIELD = LOCAL_POOL_VALUE | : LONG | : 1 | |
| TABLE = W_REDEMPTION_PAR_LEVEL | | | |
| FIELD = RECORD_ID | : LONG | : 1 | : PK |
| FIELD = REDEMPTION_ID | : LONG | : 1 | |
| FIELD = PAR_LEVEL | : BIN | : 1 | |
| FIELD = ADJUSTED_PAR_SCORE | : LONG | : 1 | |
| TABLE = W_SERVICE_ACCESSES | | | |
| FIELD = RECORD_ID | : LONG | : 1 | : PK |
| FIELD = SERVICE_ID | : LONG | : 1 | |
| FIELD = PROFILE | : BIN | : 1 | |
| FIELD = START_DATE_TIME | : LONG | : 1 | |
| FIELD = END_DATE_TIME | : LONG | : 1 | |
| FIELD = SUBSCRIBER_ID | : LONG | : 1 | |
| FIELD = CASH_FUNDS_USED | : LONG | : 1 | |
| FIELD = ACCOUNT_FUNDS_USED | : LONG | : 1 | |
| TABLE = W_SERVICE_LEADERBOARD | | | |
| FIELD = RECORD_ID | : LONG | : 1 | : PK |
| FIELD = SERVICE_ID | : LONG | : 1 | |
| FIELD = PROFILE | : BIN | : 1 | |
| FIELD = LEADERBOARD_ID | : LONG | : 1 | |
| TABLE = W_TOURNAMENT_{—} | | | |
| LOCAL_POOL | | | |
| FIELD = RECORD_ID | : LONG | : 1 | : PK |
| FIELD = TOURNAMENT_ID | : LONG | : 1 | |
| FIELD = LOCAL_POOL_VALUE | : LONG | : 1 | |

I claim:

1. A method for presenting advertising to a selected person, comprising:
storing plural advertisements in a memory,
detecting the presence of a person adjacent a display apparatus,
specifically identifying said selected person,
selecting one of said plural advertisements based on the identity of the person, and
displaying the selected advertisement via the display apparatus upon detection of the selected person adjacent the display apparatus.

2. A method as defined in claim 1, in which the detecting step comprises detecting an identity of a specific person or class of person adjacent a display apparatus, the selecting step includes selecting one of a predetermined sequence of advertisements for the identified person or class of person, and displaying the selected advertisement via the display apparatus where the identified person or class of person has been identified.

3. A method as defined in claim 2 in which the detecting step comprises detecting the identity of the specific person or class of person adjacent any one of plural display apparatus, and displaying the selected advertisement via said one display apparatus adjacent to which the identity of the specific person or class of person has been detected.

4. A method as defined in claim 2, including storing advertisement target indicators against specifically identified persons or classes of persons in a database, and in which the selection step is comprised of accessing the database, looking up a group of target indicators against the specifically identified person or class of person, and selecting one of a plurality of advertisements based on one of the target indicators matched to the specifically identified person or class of person for display.

5. A method as defined in claim 4 in which the selection step comprises selecting one of a sequence of advertisements indicated by a group of target indicators specific to a specifically identified person or class of person, and displaying a respective successive advertisement of the sequence of advertisements in sequence on the display apparatus each time the specific person or class of person corresponding to the sequence of target indicators is identified as being located adjacent the display apparatus.

6. A method as defined in claim 5 in which the detecting step comprises detecting the identity of the specific person or class of person adjacent any of plural display apparatus, and displaying the selected advertisement via the specific display apparatus adjacent to which the identity of the specific person or class of person has been detected.

7. A method as defined in claim 1, wherein failure to identify a selected person, results in the selection step selecting a further sequence of advertisements, and displaying an advertisement in the further sequence on the display apparatus each time a specific interaction with the display device or peripheral control devices by a person who is not a specifically identified person or class of person has been detected to be adjacent the display apparatus.

8. A method as defined in claim 1, in which the detecting step comprises detecting an identity of a specific person or class of person adjacent a display apparatus and a specific activity of the specific person or class of person, the selecting step includes selecting one of a predetermined sequence of advertisements for the specific activity of, and the identified person or class of person, and displaying the selected advertisement via the display apparatus where the identified person or class of person has been identified.

9. A method as defined in claim 8 in which the detecting step comprises detecting the activity and identity of the specific person or class of person adjacent any of plural display apparatus, and displaying the selected advertisement via the specific display apparatus adjacent to which the identity of the specific person or class of person has been detected.

10. A method as defined in claim 1, in which the detecting step comprises detecting the presence of a person or class of person to be adjacent a display apparatus, detecting an activity of the person or class of person, the selecting step including selecting one of a predetermined sequence of advertisements related to the presence of the person or class of person and to occurrence of the activity, and displaying the selected advertisement via the display apparatus adjacent to which the presence of the person or class of person has been identified.

11. A method as defined in claim 8 including storing advertisement target indicators against an indication of an identified person or class of person in a database, and in which the selection step is comprised of accessing the database, looking up a group of target indicators against the presence of an identified person or class of person and the occurrence of the activity, and selecting one of a plurality of advertisements based on one of the target indicators matched to the presence of an identified person or class of person and the occurrence of the activity, for display.

12. A method as defined in claim 11 in which the selection step comprises selecting one of a sequence of advertisements indicated by a group of target indicators specific to the presence of a person or class of person and to the occurrence of the activity, and displaying a respective successive advertisement of the sequence of advertisements in sequence on the display apparatus each time the presence of the person or class of person and the activity corresponding to the sequence of target indicators is identified as being located and performed adjacent the display apparatus.

13. A method as defined in claim 11 in which the sequence of advertisements is repeated once an advertisement at an end of the sequence has been displayed on the display apparatus.

14. A method as defined in claim 4, including storing the database in a server, accessing the server upon detection of the presence of a specifically identified person or class of person and downloading a control signal corresponding to the one or a group of target indicators to an advertisement player to control operation of the advertisement player to play one or a sequence of advertisements on the display apparatus.

15. A method as defined in claim 5, including storing the database in a server, accessing the server upon detection of the presence of a person or class of person and the activity and downloading a control signal corresponding to the one or a group of target indicators to an advertisement player to control operation of the advertisement player to play one or a sequence of advertisements on the display apparatus.

16. A method as defined in claim 14, in which the step of detecting a person or class of person is comprised of detecting a signal generated by any one of a card swipe terminal, a bar code reader, a magnetic code reader, a smart card reader, a keyboard or keypad and a personal attribute detector.

17. A method as defined in claim 15, in which the step of detecting a person or class of person is comprised of detecting a signal generated by any one of a card swipe terminal, a bar code reader, a magnetic code reader, a smart card reader, a keyboard or keypad and a personal attribute detector.

18. A method as defined in claim 1, including restricting display of predetermined ones of the advertisements on predetermined display apparatus, and allowing display of the restricted advertisements on other display apparatus.

19. A method as defined in claim 14, including downloading a restriction code with the control signal for restricting display of predetermined ones of the advertisements on predetermined display apparatus.

20. A method as defined in claim 15, including downloading a restriction code with the control signal for restricting display of predetermined ones of the advertisements on predetermined display apparatus.

21. A method as defined in claim 2, including the further step of crediting a specifically identified person to which an advertisement has been displayed on the display apparatus, with loyalty points, and storing the credited loyalty points in a database.

22. A method as defined in claim 2, including the further step of automatically decrementing loyalty point or monetary credits from an account of an advertiser, in the event of displaying on the display apparatus an advertisement of the advertiser to a specifically identified person or class of persons, and incrementing an account of an administrator by the amount of the decremented credits.

23. A method as defined in claim 2, including selecting an advertisement for display based on one of, time of day and viewing history of an advertisement, by a specific identified person or class of person.

24. A method as defined in claim 2 comprising including a demographic limit parameter in an advertisement selection control signal for controlling at least one of: particular location of display apparatus on which an advertisement is allowed to be displayed, time of day of display of an advertisement, a number of times that an advertisement is allowed to be run in total, a number of times that an advertisement should be allowed to be displayed in any time interval, and a number of times that and advertisement should be displayed to a particular identified person or class of person.

25. A method as defined in claim 1 including selecting an advertisement for display on at least one display apparatus based on a predetermined algorithm.

26. A method as defined in claim 1, and selecting an advertisement for display on the display apparatus based on a predetermined algorithm when the presence of a person has not been detected to be adjacent the display apparatus.

27. A system for providing advertising to a person or class of person comprising:
(a) a display apparatus,
(b) apparatus for identifying a specific person or class of person located adjacent the display apparatus,
(c) an advertising player for playing advertisements on the display apparatus,
(d) a database stored in a memory, the database containing correlations of advertisements with at least one of: persons or class of persons, and activities undertaken by or on behalf of persons or classes of persons to which predetermined sequences of advertisements are to be displayed, and
(e) apparatus for detecting an activity undertaken by or on behalf of a person or class of person, and for accessing the database and for selecting an advertisement from a group of advertisements correlated to at least one of an activity, person and class of person, and for providing a control code to the advertising player to cause a particular advertisement or sequence of advertisements to be displayed on the display apparatus.

28. Apparatus as defined in claim 27, in which the database includes at least one exclusion code for restricting display of an advertisement on a particular one or group of display apparatus.

29. Apparatus as defined in claim 27, including means for providing a filter code into the control code for controlling restriction of predetermined advertisements from being displayed on the display apparatus.

30. A method as defined in claim 1 in which the selection step comprises selecting one of a sequence of advertisements indicated by a group of target indicators specific to a specifically identified person or class of person, and displaying a respective successive advertisement of the sequence of advertisements in sequence on the display apparatus each time the specific person or class of person corresponding to the sequence of target indicators is identified as being located adjacent the display apparatus.

31. A method as defined in claim 30 in which the detecting step comprises detecting the identity of the specific person or class of person adjacent any of plural display apparatus, and displaying the selected advertisement via the specific display apparatus adjacent to which the identity of the specific person or class of person has been detected.

32. A method as defined in claim 1, including the further step of automatically decrementing loyalty point or monetary credits from an account of an advertiser, in the event of displaying on the display apparatus an advertisement of the advertiser to a specifically identified person or class of persons, and incrementing an account of an administrator by the amount of the decremented credits.

33. A method as defined in claim 32, including selecting an advertisement for display based on one of time of day and viewing history of an advertisement with respect to a specific identified person or class or person.
